(19) United States
(12) Patent Application Publication
(10) Pub. No.: US 2024/0215610 A1
(43) Pub. Date: Jul. 4, 2024

(54) EXTRUDED FOOD PRODUCT COMPRISING PLANT PROTEIN AND HYDROCOLLOID

(71) Applicants: DuPont Nutrition Biosciences ApS, Kongens Lyngby (DK); DuPont Nutrition USA, Inc., Wilmington, DE (US); Solae LLC, St. Louis, MO (US)

(72) Inventors: THERESE FJAEREIDE, Sandvika (NO); DORTHE STENBAEK, Brabrand (DK); CASPER LUND, Brabrand (DK); SANTIAGO SOLORIO, St. Louis, MO (US); TORBEN SNABE, Brabrand (DK); KHAMFA PHONCHAREON, New Century, KS (US); ULRIK KOFOD MADSEN, Brabrand (DK); ROBIN KAY CONNELLY, St. Louis, MO (US)

(21) Appl. No.: 18/563,099

(22) PCT Filed: May 25, 2022
(86) PCT No.: PCT/US2022/030840

§ 371 Date: Nov. 21, 2023

Related U.S. Application Data
(60) Provisional application No. 63/193,135, filed on May 26, 2021.

(30) Foreign Application Priority Data
Aug. 26, 2021 (EP) 21193271.0

(51) Int. Cl. A23J 3/16; A23J 3/22; A23J 3/26; A23L 29/212; A23L 29/256; A23P 30/20

(52) U.S. Cl. CPC A23J 3/16; A23J 3/227; A23J 3/26; A23L 29/212; A23L 29/256; A23P 30/20

(57) ABSTRACT

This disclosure relates to an extrudate which contains, by weight based on the weight of the extrudate on a moisture-free basis, (a) from about 60% to about 90% plant protein; (b) from about 1% to about 10% hydrocolloid, wherein the hydrocolloid is selected from the group consisting of alginate, pectin, agar, methylcellulose, and mixtures thereof; and (c) optionally, no more than about 14% starch. This disclosure also relates to a dry-blend composition which contains, by weight based on the total weight of the dry-blend composition on a moisture-free basis, (a) from about 65% to about 98% plant protein material, (b) from about 1% to about 10% hydrocolloid, wherein the hydrocolloid is selected from the group consisting of alginate, pectin, agar, methylcellulose, and mixtures thereof; and (c) optionally, no more than about 14% starch.

### CROSS-REFERENCE TO RELATED APPLICATION

This application claims priority to U.S. Patent Application Ser. No. 63/193,135 filed on May 26, 2021 and EP Patent Application 21193271 filed on Aug. 26, 2021, the contents of both applications are incorporated herein by reference in their entirety for all purposes.

### BACKGROUND

### Field of the Disclosure

The present disclosure relates to an extrudate made from plant proteins, to an extrusion process of making such extrudate, to a composition for use in the extrusion process of making such extrudate, and to a process of preparing a food product, such as a meat-alternative food product, by using such extrudate.

### Description of Related Art

Expanded low moisture structured meat analog products are well known in the art and they are typically prepared by heating a mixture containing protein materials and other ingredients along with water under mechanical shearing and pressure in a cooker extruder and extruding the mixture through a die. Upon extrusion, the extrudate generally expands and contracts based on the extrusion conditions and the rheological properties of the materials being extruded.

The formation of the extrudate will be defined on the selection of the ingredients extruded, such as combination of proteins, carbohydrates, fibers, etc., and the design and set up of the extrusion cooking devices. Typical extrusion process is designed and run using steady-state conditions to manufacture similar products in a continuous based process; these products present similar attributes in shape and external dimension.

Extrusion cooking devices have long been used in the manufacture of a wide variety of edible and other products such as human and animal feeds. Extruders include an elongated barrel together with one or more internal, helically flighted, axially rotatable extrusion screws therein. The outlet of the extruder barrel is equipped with a single or multiple opening in the extrusion die. In use, a material to be processed is passed into and through the extruder. As the material emerges from the extruder die opening(s), it is shaped, and it may typically be subdivided using a rotating knife assembly. Alternatively, the expanded protein product may be cut into smaller extrudates such as chunks, granules, strips, shreds, etc. for use as food, food ingredients or meat alternative applications.

In use, a material to be processed is passed into and through the extruder barrel and is subjected to increasing levels of temperature, pressure, and shear. The material emerges from the extruder die opening(s) in a rope format that is fully cooked and ready for further processing to produce the desired end products. Typical texturized protein processed extrudates or “rope” products are uniform products that have sensory characteristics like processed food, fabricated, or non-natural food products that consumers view with hesitation. This uniform “rope” product requires further processing to create a desired consumer product to define the final form or shape such as chunks, strips, shreds, etc. With the additional processing, the products typically look like processed, fabricated, or non-natural food products.

Therefore, there is a need to produce better and alternative structured protein products that possesses the sensory characteristics of an irregular external shape and irregular internal structure of non-fabricated appearance to mimic natural structured foods for meat substitutes or meat analog food applications.

### BRIEF SUMMARY OF THE DISCLOSURE

The present disclosure provides an extrudate comprising, by weight based on the weight of the extrudate on a moisture-free basis, (a) from about 60% to about 90% plant protein; (b) from about 1% to about 10% hydrocolloid, wherein the hydrocolloid is selected from the group consisting of alginate, pectin, agar, methylcellulose, and mixtures thereof; and (c) optionally, no more than about 14% starch.

The present disclosure also provides a dry-blend composition comprising, by weight based on the total weight of the dry-blend composition on a moisture-free basis, (a) from about 65% to about 98% plant protein material, (b) from about 1% to about 10% hydrocolloid, wherein the hydrocolloid is selected from the group consisting of alginate, pectin, agar, methylcellulose, and mixtures thereof; and (c) optionally, no more than about 14% starch.

The present disclosure also provides an extrusion process comprising: (a) contacting the dry-blend composition of this disclosure with water to form a feed mixture, (b) feeding the feed mixture into an extruder to form a molten extrusion mass, and (c) extruding the molten extrusion mass through an extrusion die to produce an extrudate.

The present disclosure also provides a process of preparing a hydrated extrudate. The process comprises hydrating the extrudate of this disclosure in an aqueous solution to form the hydrated extrudate.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. For example, when a range of “1 to 10” is recited, the recited range should be construed as including ranges “1 to 8”, “3 to 10”, “2 to 7”, “1.5 to 6”, “3.4 to 7.8”, “1 to 2 and 7-10”, “2 to 4 and 6 to 9”, “1 to 3.6 and 7.2 to 8.9”, “1-5 and 10”, “2 and 8 to 10”, “1.5-4 and 8”, and the like.

While compositions and methods are described herein in terms of “comprising” various components or steps, the compositions and methods also can “consist essentially of” or “consist of” the various components or steps, unless stated otherwise.

Before addressing details of embodiments described below, some terms are defined or clarified.

The term “wt %”, as used herein, means percentage by weight.

The term “GDL content”, as used herein, means the total amount of glucono delta-lactone, gluconic acid and salt(s) of gluconic acid in a material, by weight based on the weight of the material on a moisture-free basis.

The term “on a moisture-free basis”, as used herein with reference to a specific weight, means the weight of a material after it has been dried to completely remove all moisture, e.g., the moisture content of the material is 0%. Specifically, the weight on a moisture-free basis of a material can be obtained by weighing the material after the material has been placed in a 45° C. oven until the material reaches a constant weight.

### Plant Protein

The term “plant protein”, as used herein, means a protein derived from a plant. Examples of plants include legume, canola, sunflowers, sorghum, rice, amaranth, potato, tapioca, arrowroot, canna, lupin, cereal grains such as wheat, corn/maize, oats, barley, millet, triticale, buckwheat, rye, peanut, lupin, rapeseed, cassava, hemp, and grass. In some embodiments, the plant protein can be derived from the seeds of legumes such as soybean, mung bean, chickpea, lentil, and pea. In some embodiments, the plant protein is selected from the group consisting of soy protein, pea protein, potato protein, wheat gluten, lentil protein, fava protein, rice protein, canola protein, corn protein, jackfruit protein, sunflower protein, chickpea protein, and combinations thereof. In some embodiments, the plant protein is selected from the group consisting of soy protein, pea protein, potato protein, and combinations thereof. In some embodiments, the plant protein is a soy protein. In some embodiments, the plant protein is a mixture of soy protein and potato protein. In some embodiments, the plant protein is a pea protein. In some embodiments, the plant protein comprises, consists essentially of or consists of a soy protein. In some embodiments, the plant protein comprises, by weight based on the weight of the plant protein, at least 80%, 85%, 90%, 92%, 95%, 98%, or 99% soy protein.

A plant protein material is used in the extrusion processes of this disclosure to make the extrudates. In some embodiments, the plant protein material comprises, by weight based on the weight of the plant protein material on a moisture-free basis, at least about 60%, 70%, 80%, or 90% plant protein. In some embodiments, the plant protein material is selected from the group consisting of soy protein materials, pea protein materials, and combinations thereof. A suitable pea protein material can be selected from the group consisting of pea protein isolate, pea protein concentrate, and combinations thereof.

A suitable soy protein material which can be used in the extrusion processes of this disclosure to make the extrudates can be selected from the group consisting of soy protein isolate, soy protein concentrate, soy flour, soy flake, soy grit, soy meal, and combinations thereof. The primary difference between these soy protein materials is the degree of refinement and/or particle size. A soy protein isolate (SPI) has the highest degree of “soy” purity among all the soy protein materials and comprises at least about 90 wt % soy protein based on the weight of the soy protein isolate on a moisture-free basis. In some embodiments, the soy protein isolate comprises, consists essentially of or consists of, by weight based on the weight of the soy protein isolate on a moisture-free basis, about 90% to about 92% soy protein, about 0.5% to about 1.0% oil, about 3% to about 4% carbohydrates, about 4% to about 5% ash, and about 0.1% to about 0.2% fiber.

A soy protein concentrate comprises, by weight based on the weight of the soy protein concentrate on a moisture-free basis, about 65% to about 90% soy protein and about 3.5% to about 20% soy cotyledon fiber. The term “soy flour” as used herein, refers to a comminuted form of defatted soybean. In some embodiments, the soy flour comprises, by weight based on the weight of the soy flour on a moisture-free basis, about 49% to about 60% soy protein and less than about 1% oil. In some embodiments, the soy flour is very finely ground so that less than about 1 wt % of the soy flour is retained on a 300 mesh (U.S. Standard) screen. Soy flour generally has a particle size of less than about 150 μm. Soy grit generally has a particle size of from about 150 μm to about 1000 μm. Soy meal generally has a particle size of greater than about 1000 μm.

In some embodiments, a soy protein material which can be used in the extrusion processes of this disclosure to make the extrudates is selected from the group consisting of soy protein isolate, soy protein concentrate, soy flour, and combinations thereof. In some embodiments, the soy protein material is selected from the group consisting of soy protein isolate, soy protein concentrate, and combinations thereof. In some embodiments, the soy protein material is soy protein isolate.

### Hydrocolloid

The term “hydrocolloid”, as used herein, means a substance usually a polysaccharide that is colloidally dispersible in water changing the rheology of water by raising the viscosity and/or inducing gelation of the substance in which it is used. In some embodiments, the hydrocolloid in this disclosure is selected from the group consisting of alginate, pectin, agar, methylcellulose, gellan gum (e.g., low acyl gellan gum), curdlan gum, and mixtures thereof. In some embodiments, the hydrocolloid is selected from the group consisting of alginate, pectin, agar, methylcellulose, and mixtures thereof. In some embodiments, the hydrocolloid is alginate. In some embodiments, the hydrocolloid is a mixture of alginate and pectin. In some embodiments, the hydrocolloid is a pectin. In some embodiments, the hydrocolloid comprises, consists essentially of or consists of an alginate. In some embodiments, the hydrocolloid comprises, by weight based on the weight of the hydrocolloid, at least 80%, 85%, 90%, 92%, 95%, 98%, or 99% alginate.

Alginates, derived from, inter alia, brown seaweeds are linear, unbranched bio-polymers consisting of (1-4)-linked β-D-mannuronic acid (M) and α-L-guluronic acid (G) residues. Alginates consist of homopolymeric blocks of consecutive G residues, consecutive M residues, or alternating M and G residues, for example, MMMM, GGGG, and GMGM. The number of G residues with respect to the sum of G and M residues is known as G content. Similarly the percent content of M residues is known as M content, such that the G content and M content account for 100%. In some embodiments, the alginate has a G content that is at least 20%, or at least 25%, or at least 30%, or at least 32%, or at least 35%, or at least 38%, or at least 40%, or at least 42%, or at least 45%, or at least 48%, or at least 50%, or at least 52%, or at least 55%, or at least 57%, or at least 60%. In some embodiments, the alginate has a G content that is no more than 75%, or no more than 72%, or no more than 70%, or no more than 68%, or no more than 65%, or no more than 62%, or no more than 60%, or no more than 58%, or no more than 55%, or no more than 52%, or no more than 50%, or no more than 48%, or no more than 45%, or no more than 42%, or no more than 40%.

“Alginate” is the term usually used for the salts of alginic acid, but it can also refer to all the derivatives of alginic acid and alginic acid itself. In some embodiments, the alginate in this disclosure has a molecular weight such that the alginate in the form of sodium alginate exhibits a viscosity in the range of 50-1,000 mPa's when measured at 1 wt % at 20° C. using Brookfield type RV (e.g. RVT, RVF, RVTDV) with Brookfield RV using the appropriate spindle for the viscosity range in question. The appropriate spindle for the viscosity determination can be readily determined by one of ordinary skill in the art, based on the equipment model and the viscosity range. In some embodiments, such alginate in the form of sodium alginate exhibits a viscosity of from 200 mPas to 600 mPas when so measured. In some embodiments, two or more types of alginate can be used in combination. In some embodiments, a single type of alginate is used.

In some embodiments, the hydrocolloid is a pectin. In some embodiments, the pectin is a sugar beet pectin, that is, the pectin is extracted or derived from sugar beet. In some embodiments, the pectin is a citrus peel pectin, that is, the pectin is extracted or derived from citrus peel. In some embodiments, the pectin is an apple pomace pectin, that is, the pectin is extracted or derived from apple pomace. The pectin can be a hydrolyzed pectin or an unhydrolyzed pectin. In some embodiments, the pectin is an amidated pectin, such as an amidated pectin having DE of no more than 50.

Main component of pectin is galacturonic acid. The degree of esterification (DE) of pectin is the number of esterified carboxyl groups per 100 equivalents of galacturonic acid. In some embodiments, the pectin has an averaged degree of esterification (DE) of at least 15, or at least 20, or at least 25, or at least 30, or at least 35, or at least 40, or at least 45, or at least 50, or at least 55, or at least 60. In some embodiments, the pectin has an averaged degree of esterification (DE) of no more than 80, or no more than 75, or no more than 70, or no more than 65, or no more than 60, or no more than 55, or no more than 50, or no more than 45.

In some embodiments, the hydrocolloid is an agar. In some embodiments, the hydrocolloid is methylcellulose.

### Calcium Ions

Source of calcium ions (Ca²⁺) in this disclosure can be a calcium-containing compound. In some embodiments, the source of calcium ions is a sparingly soluble calcium compound. As is employed herein, the term “sparingly soluble” when applied to calcium compounds means that the calcium compound has a low solubility product, as defined hereinbelow. The solubility product is the product of the equilibrium molar concentrations of the ions in a saturated solution of a compound in water. “Low solubility product” as used in the practice of the present invention is typically not more than 102 at 25° C., preferably not more than 10⁻³, more preferably not more than 10⁻⁴. In some embodiments, the sparingly soluble calcium compound is selected from the group consisting of calcium sulphate, calcium phosphates (e.g., di-calcium phosphate), calcium citrate, calcium carbonate, calcium silicate, calcium sulfide, calcium tartrate, and mixtures thereof. In some embodiments, the sparingly soluble calcium compound is selected from the group consisting of calcium sulphate, di-calcium phosphate, calcium carbonate, and mixtures thereof. The sparingly soluble calcium compound in this disclosure includes anhydrous and hydrated ones.

In some embodiments, the source of calcium ions is a calcium-containing compound selected from the group consisting of calcium alginate, calcium sulphate, calcium carbonate, calcium phosphate, di-calcium phosphate, calcium chloride, (encapsulated) calcium lactate, and mixtures thereof. In some embodiments, the source of calcium ions is calcium alginate. The calcium-containing compound can be encapsulated or unencapsulated.

### Sequestrant and Acidifier

Alginates instantly gel in the presence of divalent cations such as calcium ions. Therefore, it is important to control the presence of calcium ions in the extrusion process, so that the desired properties of the extrudate products are obtained. This may be done by using slow-release calcium compounds such as sparingly soluble calcium compounds, optionally in combination with a sequestrant.

A sequestrant is a chelating agent that typically has a higher affinity for calcium ions than alginate. In some embodiments, the sequestrant is selected from the group consisting of tetrasodium pyrophosphate (TSPP), trisodium phosphate (TSP), disodium phosphate (DSP), sodium hexametaphosphate (SHMP), trisodium citrate, sodium tripolyphosphate (STPP), sodium carbonate, ethylene diamine tetra-acetate (EDTA), sodium gluconate, potassium gluconate, and mixtures thereof. In some embodiments, the sequestrant is selected from the group consisting of tetrasodium pyrophosphate (TSPP), trisodium phosphate (TSP), disodium phosphate (DSP), sodium hexametaphosphate (SHMP), trisodium citrate, and mixtures thereof. The sequestrant in this disclosure includes anhydrous and hydrated ones.

Alternatively, the presence of calcium ions can be controlled by using a sparingly soluble calcium compound which becomes more soluble at lower pH, such as calcium carbonate and di-calcium phosphate, in combination with an acidifier (pH control agent/sequestrant), such as glucono delta-lactone (GDL). The acidifier lowers the pH over time and thereby releases the calcium ions from calcium carbonate and di-calcium phosphate in a controlled way. In some embodiments, the acidifier is GDL. In some embodiments, the acidifier comprises, consists essentially of or consists of GDL. In some embodiments, the acidifier comprises, by weight based on the weight of the acidifier, at least 80%, 85%, 90%, 92%, 95%, 98%, or 99% GDL.

### Starch and Fiber

Starch and/or fiber can be used in the extrusion processes of this disclosure to make the extrudates. They may modify the internal and external structures of the extrudate products, help improve the flowability of the feed mixture in the extrusion process and modify the stability of the extrudate flow through the die configuration. Starch in this disclosure can be a native starch and/or a modified starch. In some embodiments, the starch is selected from the group consisting of tapioca starch (e.g., native tapioca starch), wheat starch, potato starch (e.g., native potato starch), corn starch, rice starch, pea starch, barley starch, arrowroot starch, and mixtures thereof. In some embodiments, the starch is selected from the group consisting of tapioca starch, wheat starch, potato starch, and mixtures thereof. In some embodiments, the starch is a tapioca starch. In some embodiments, the starch comprises, consists essentially of or consists of a tapioca starch. In some embodiments, the starch comprises, by weight based on the weight of the starch, at least 80%, 85%, 90%, 92%, 95%, 98%, or 99% tapioca starch.

The term “added fiber ingredient”, as used herein, means an ingredient (used in the extrusion processes of this disclosure to make the extrudates) which comprises dietary carbohydrate fibers, such as insoluble dietary fiber (IDF) and soluble dietary fiber (SDF). Added fiber ingredient to be used in the extrudate may be derived from e.g., wheat bran, corn bran, whole grain, breads, cereals, vegetables such as cabbage, carrots, and sprouts (such as brussel sprouts), fruits such as apples, bananas, and citrus, seaweed, mushrooms, oats, barley, and legumes such as soybeans and peas. For the purpose of clarity, in this disclosure, the added fiber ingredient excludes plant protein materials, such as soy protein materials (e.g., soy protein isolate and soy protein concentrate), which may contain fibers.

In some embodiments, the added fiber ingredient is selected from the group consisting of soy fiber, citrus fiber, pea fiber, and mixtures thereof. In some embodiments, the added fiber ingredient is selected from the group consisting of soy fiber, citrus fiber, and mixtures thereof. In some embodiments, the soy fiber is a soy cotyledon fiber. In some embodiments, the added fiber ingredient is a citrus fiber.

### Extrudate

The present disclosure provides an extrudate suitable for meat-alternative products, comprising, by weight based on the weight of the extrudate on a moisture-free basis, (a) from about 60% to about 90% plant protein; (b) from about 1% to about 10% hydrocolloid, wherein the hydrocolloid is selected from the group consisting of alginate, pectin, agar, methylcellulose, and mixtures thereof; and (c) optionally, no more than about 14% starch. It has been discovered that an extrudate, comprising high concentration of plant protein, a hydrocolloid, and additional ingredients such as starch, fiber, calcium compound, etc. can be manufactured to have the desired internal and external structures to mimic non-fabricated irregular whole muscle chunks, dices, strips, cubes, etc. meeting the sensorial attributes in the final applications. The extrudates of this disclosure possess improved features in terms of sensory characteristics of an irregular external shape and irregular internal structure mimicking the appearance of non-fabricated natural structured foods for meat.

The term “extrudate”, as used herein, means the product of an extrusion process. An extrusion process can be a high-moisture extrusion (HME) process or a low-moisture extrusion (LME) process. The term “low-moisture extrusion”, as used herein, means an extrusion process carried out with less than 40 wt % of moisture (water or a combination of water and other liquids) in the extrusion mass (based on the total weight of the extrusion mass). Such extrusion process is also known as direct expanded process. The term “low-moisture extrudate”, as used herein, means the extrudate produced by a low-moisture extrusion process. The extrudate products from a low-moisture extrusion are usually expanded and present honeycomb structure and have a sponge-like structure and absorb water rapidly. In some embodiments, the extrudate is a low-moisture extrudate.

The term “high-moisture extrusion”, as used herein, means an extrusion process carried out with more than 50 wt % of moisture (water or a combination of water and other liquids) in the extrusion mass (based on the total weight of the extrusion mass). The term “high-moisture extrudate”, as used herein, means the extrudate produced by a high-moisture extrusion process. In some embodiments, the extrudate is a high-moisture extrudate.

The extrudate in this disclosure comprises, by weight based on the weight of the extrudate on a moisture-free basis, from about 60% to about 90% plant protein. In some embodiments, the extrudate comprises, by weight based on the weight of the extrudate on a moisture-free basis, at least about 60%, 62%, 64%, 66%, 68%, 70%, 72%, 74%, 76%, 78%, 80%, or 82% plant protein. In some embodiments, the extrudate comprises, by weight based on the weight of the extrudate on a moisture-free basis, no more than about 90%, 89%, 88%, 87%, 86%, 85%, 83%, 81%, 79%, 77%, 75%, 73%, or 71% plant protein. In some embodiments, the extrudate comprises, by weight based on the weight of the extrudate on a moisture-free basis, from about 70% to about 90%, from about 76% to about 86%, or from about 80% to about 90% plant protein. In some embodiments, the plant protein is soy protein.

In some embodiments, the extrudate comprises, by weight based on the weight of the extrudate on a moisture-free basis, from about 70% to about 95%, or from about 75% to about 94%, or from about 80% to about 94% soy protein isolate. In some embodiments, the extrudate comprises, by weight based on the weight of the extrudate on a moisture-free basis, at least about 65%, 70%, 72%, 75%, 76%, 77%, 78%, 79%, 80%, 81%, 82%, 83%, 84%, 85%, or 86% soy protein isolate. In some embodiments, the extrudate comprises, by weight based on the weight of the extrudate on a moisture-free basis, no more than about 97%, 96%, 95%, 94%, 93%, 92%, 91%, or 90% soy protein isolate.

In some embodiments, a soy protein isolate is used in the extrusion process to make the extrudate, and the extrudate comprises, by weight based on the weight of the extrudate on a moisture-free basis, no more than 3%, 2%, or 1% oil. In some embodiments, the extrudate comprises, by weight based on the weight of the extrudate on a moisture-free basis, no more than 2%, 1%, 0.5% or 0.2% fiber.

In some embodiments, the extrudate comprises, by weight based on the weight of the extrudate on a moisture-free basis, no more than about 20%, 16%, 14%, 13%, 12%, 11%, 10%, 9%, 8%, 7%, or 6% starch. In some embodiments, the extrudate comprises, by weight based on the weight of the extrudate on a moisture-free basis, at least about 0.001%, 0.01%, 0.1%, 0.5%, 1%, 2%, 3%, 4%, or 5% starch. In some embodiments, the extrudate comprises, by weight based on the weight of the extrudate on a moisture-free basis, from about 1% to about 14%, or from about 1% to about 10%, or from about 2% to about 10%, or from about 2% to about 9%, or from about 3% to about 8% starch.

The extrudate in this disclosure comprises, by weight based on the weight of the extrudate on a moisture-free basis, from about 1% to about 10%, or from about 1% to about 8%, or from about 1% to about 7%, or from about 2% to about 6% hydrocolloid. In some embodiments, the extrudate comprises, by weight based on the weight of the extrudate on a moisture-free basis, at least about 1%, 1.5%, 2%, 2.5%, 3%, 3.5%, or 4% hydrocolloid. In some embodiments, the extrudate comprises, by weight based on the weight of the extrudate on a moisture-free basis, no more than about 10%, 9%, 8%, 7%, 6.5%, 6%, 5.5%, 5%, 4.5% or 4% hydrocolloid. In some embodiments, the hydrocolloid is an alginate which can be present in the extrudate in one or more forms of alginic acid, derivatives of alginic acid, and/or salts of alginic acid such as calcium alginate, potassium alginate and sodium alginate. In some embodiments, the alginate is present in the extrudate in the forms of sodium alginate and calcium alginate. In some embodiments, the alginate is present in the extrudate in the form of calcium alginate. In some embodiments, the hydrocolloid is a combination of sodium alginate and calcium alginate.

In some embodiments, the hydrocolloid comprises, consists essentially of or consists of an alginate, and the extrudate further comprises calcium ions. Calcium in the extrudate can be present in the forms of calcium alginate and other calcium-containing compounds. In some embodiments, the extrudate has calcium content ranging from about 0.01% to about 10%, or from about 0.05% to about 5%, or from about 0.1% to about 3%, or from about 0.1% to about 2%, or from about 0.2% to about 1%, or from about 0.3% to about 1%, or from about 0.4% to about 1%, or from about 0.5% to about 0.9%. In some embodiments, the extrudate has calcium content of at least about 0.01%, 0.02%, 0.05%, 0.08%, 0.1%, 0.15%, 0.2%, 0.25%, 0.3%, 0.35%, 0.4%, 0.45%, or 0.5%. In some embodiments, the extrudate has calcium content of no more than about 10%, 8%, 6%, 5%, 4%, 3%, 2%, 1.5%, 1.2%, 1%, 0.9%, 0.8%, 0.7%, or 0.6%.

In some embodiments, the extrudate comprises, by weight based on the weight of the extrudate on a moisture-free basis, from about 1% to about 10%, or from about 2% to about 8%, or from about 4% to about 6% calcium alginate. In some embodiments, the extrudate comprises, by weight based on the weight of the extrudate on a moisture-free basis, at least about 0.2%, 0.5%, 1%, 2%, 3%, or 4% calcium alginate. In some embodiments, the extrudate comprises, by weight based on the weight of the extrudate on a moisture-free basis, no more than about 15%, 12%, 10%, 9%, 8%, 7%, 6%, 5%, or 4% calcium alginate.

In some embodiments, the hydrocolloid is a pectin (e.g., pectin having an averaged DE of at least 50), and the extrudate has calcium content of no more than about 0.5%, 0.4%, 0.3%, 0.2%, 0.1%, 0.08%, 0.05%, 0.02%, or 0.01%. In some embodiments, the extrudate is substantially free or free of calcium ions.

In embodiments wherein the extrudate comprises alginate and calcium ions, optionally the extrudate further comprises a sequestrant or an acidifier, that is, a sequestrant or an acidifier can be used in the extrusion process to make the extrudate. A person skilled in the art appreciates that a portion or all of the sequestrant can be transformed into a different compound (product) during the extrusion process. For example, a portion or all of disodium phosphate can become calcium phosphate (product) and a portion or all of pyrophosphate can become phosphate (product) after the extrusion. A person skilled in the art also appreciates that a portion or all of glucono delta-lactone (GDL) can be hydrolyzed to gluconic acid and/or its salt (product) during the extrusion process. By “the extrudate comprises a sequestrant” it is meant the extrudate comprises a sequestrant (if there is residue after the extrusion) and its corresponding product in the extrusion. Similarly, by “the extrudate comprises an acidifier” it is meant the extrudate comprises an acidifier (if there is residue after the extrusion) and its corresponding product in the extrusion.

In some embodiments, the extrudate comprises a sequestrant. In some embodiments, the extrudate comprises a sequestrant selected from the group consisting of tetra sodium pyrophosphate (TSPP), trisodium phosphate (TSP), disodium phosphate (DSP), sodium-hexametaphosphate (SHMP), trisodium citrate, and mixtures thereof. In some embodiments, the extrudate comprises an acidifier. In some embodiments, the extrudate comprises an acidifier which is glucono delta-lactone (GDL). In some embodiments, the extrudate comprises a gluconic acid and/or its salt. In some embodiments, the extrudate comprises a sequestrant present in the extrudate as a phosphate compound.

The amount of sequestrant used in the extrusion process to make the extrudate is typically less than the stoichiometric amount to bind the calcium ions. In some embodiments, the amount of sequestrant (i.e., sequestrant and its corresponding product in the extrusion) present in the extrudate ranges from about 20% to about 85%, or from about 30% to about 80%, or from about 40% to about 75%, or from about 50% to about 75% of the stoichiometric amount. By “stoichiometric amount (of sequestrant)” it is meant the amount of sequestrant needed to bind the amount of calcium ions present in the extrudate. In some embodiments, the amount of sequestrant present in the extrudate is at least about 10%, 20%, 30%, 40%, 50%, 60%, or 70% of the stoichiometric amount. In some embodiments, the amount of sequestrant present in the extrudate is no more than about 90%, 85%, 80%, 75%, 70%, or 65% of the stoichiometric amount.

In some embodiments, the extrudate comprises, by weight based on the weight of the extrudate on a moisture-free basis, from about 0.1% to about 10%, or from about 0.2% to about 8%, or from about 0.4% to about 5%, or from about 0.5% to about 3% acidifier. In some embodiments, the extrudate comprises, by weight based on the weight of the extrudate on a moisture-free basis, at least about 0.05%, 0.1%, 0.2%, 0.3%, 0.4%, 0.5%, 0.6%, 0.7%, or 0.8% acidifier. In some embodiments, the extrudate comprises, by weight based on the weight of the extrudate on a moisture-free basis, no more than about 15%, 12%, 10%, 9%, 8%, 7%, 6%, 5%, 4%, 3%, or 2% acidifier.

In some embodiments, the extrudate has GDL content ranging from about 0.1% to about 10%, or from about 0.2% to about 8%, or from about 0.4% to about 5%, or from about 0.5% to about 3%. In some embodiments, the extrudate has GDL content of at least about 0.05%, 0.1%, 0.2%, 0.3%, 0.4%, 0.5%, 0.6%, 0.7%, or 0.8%. In some embodiments, the extrudate has GDL content of no more than about 15%, 12%, 10%, 9%, 8%, 7%, 6%, 5%, 4%, 3%, or 2%.

In some embodiments, the extrudate consists essentially of, by weight based on the weight of the extrudate on a moisture-free basis, (a) a soy protein material so that the extrudate comprises from about 75% to about 85% soy protein; (b) from about 1% to about 5% alginate; (c) from about 1% to about 10%, or from about 2% to about 8% starch, such as tapioca starch; (d) from about 0.1% to about 5%, or from about 0.2% to about 4%, or from about 0.2% to about 3%, or from about 0.3% to about 2% calcium content; and (e) from about 1% to about 3% fiber. In some embodiments, the soy protein material is a soy protein isolate, and the component (a) is from about 81% to about 94% soy protein isolate.

In this disclosure, the claimed extrudates (dry or hydrated) possess the basic and novel characteristic(s) that the claimed extrudates have whole muscle meat analog texture providing the appearance and eating experience of non-fabricated natural structured foods for meat. For example, the dry extrudates have water binding ratio of at least about 3. For another example, the hydrated extrudate has average shear strength of at least about 2500 or 3000 grams. For yet another example, the hydrated extrudate comprises at least about 40 wt % macrostructural fibrous elements (strands, sheets and chunks).

In some embodiments, the extrudate comprises, consists essentially of or consists of, by weight based on the weight of the extrudate on a moisture-free basis, (a) from about 82% to about 94%, or from about 84% to about 92% soy protein isolate; (b) from about 1% to about 5%, or from about 2% to about 4% alginate; (c) from about 2% to about 10%, or from about 3% to about 8% starch such as tapioca starch; (d) from about 0.1% to about 1%, or from about 0.2% to about 0.8% calcium ions; and (e) optionally, from about 0.3% to about 3%, or from about 0.5% to about 2% GDL content.

In some embodiments, the extrudate comprises, consists essentially of or consists of, by weight based on the weight of the extrudate on a moisture-free basis, (a) from about 80% to about 96%, or from about 84% to about 94%, or from about 88% to about 92% soy protein isolate; (b) from about 2% to about 10%, or from about 3% to about 8%, or from about 4% to about 6% calcium alginate; and (c) from about 2% to about 10%, or from about 3% to about 8%, or from about 4% to about 6% starch such as tapioca starch. In some embodiments, such extrudate is free of a sequestrant and/or an acidifier. In some embodiments, such extrudate is free of phosphate compounds, sulphate compounds, citrate compounds, glucono delta-lactone, gluconic acid, and/or salt(s) of gluconic acid. It has been surprisingly discovered through experiments that calcium alginate alone can be used as a gelling agent in the extrusion process of this disclosure to produce extrudates having similar texture as extrudates produced with the gelling system of “sparingly soluble calcium compound+sodium or potassium alginate+sequestrant or acidifier”. Such extrudates also possess improved features in terms of sensory characteristics of an irregular external shape and irregular internal structure mimicking the appearance of non-fabricated natural structured foods for meat.

In some embodiments, the extrudate comprises, consists essentially of or consists of, by weight based on the weight of the extrudate on a moisture-free basis, (a) from about 75% to about 90%, or from about 80% to about 90% soy protein isolate; (b) from about 3% to about 8%, or from about 4% to about 6% alginate; (c) from about 3% to about 8%, or from about 4% to about 6% starch such as tapioca starch; (d) from about 0.4% to about 1.2%, or from about 0.5% to about 1% calcium ions; and (e) from about 0.7% to about 3%, or from about 1% to about 2.5% salts of pyrophosphate and phosphate.

In some embodiments, the extrudate further comprises, by weight based on the weight of the extrudate on a moisture-free basis, no more than about 6%, 5%, 4%, 3% or 2% added fiber ingredient. In some embodiments, the extrudate further comprises, by weight based on the weight of the extrudate on a moisture-free basis, at least about 1%, 2%, 3%, 4%, or 5% added fiber ingredient.

In some embodiments, the extrudate is dry. In some embodiments, the extrudate has a moisture content of no more than about 12 wt %, 10 wt %, 8 wt %, 6 wt %, 4 wt %, 2 wt %, or 1 wt % based on the total weight of the extrudate. In some embodiments, the extrudate has a moisture content of from about 1 wt % to about 12 wt %, or from about 2 wt % to about 6 wt % based on the total weight of the extrudate.

In some embodiments, the extrudate is substantially free or free of sulphate ions. In some embodiments, the extrudate comprises, by weight based on the weight of the extrudate on a moisture-free basis, no more than about 2%, 1%, 0.5%, 0.2%, or 0.1% sulphate ions. In some embodiments, the extrudate is substantially free or free of phosphate ions. In some embodiments, the extrudate comprises, by weight based on the weight of the extrudate on a moisture-free basis, no more than about 2%, 1%, 0.5%, 0.2%, or 0.1% phosphate ions.

In some embodiments, the extrudate is substantially free or free of a starch. In some embodiments, the extrudate comprises, by weight based on the weight of the extrudate on a moisture-free basis, no more than about 2%, 1%, 0.5%, 0.2%, or 0.1% starch. In some embodiments, the extrudate is substantially free or free of fibers. In some embodiments, the extrudate comprises, by weight based on the weight of the extrudate on a moisture-free basis, no more than about 2%, 1%, 0.8%, 0.7%, 0.6%, 0.5%, 0.2%, or 0.1% fibers. For the purpose of clarity, the fibers and the added fiber ingredients exclude the protein fibers formed during the extrusion process in this disclosure.

In some embodiments, the extrudate is substantially free or free of a pectin. In some embodiments, the extrudate comprises, by weight based on the weight of the extrudate on a moisture-free basis, no more than about 2%, 1%, 0.5%, 0.2%, or 0.1% pectin. In some embodiments, the extrudate is substantially free or free of a sequestrant. In some embodiments, the extrudate comprises, by weight based on the weight of the extrudate on a moisture-free basis, no more than about 2%, 1%, 0.5%, 0.2%, or 0.1% sequestrant. In some embodiments, the extrudate is substantially free or free of an acidifier. In some embodiments, the extrudate comprises, by weight based on the weight of the extrudate on a moisture-free basis, no more than about 2%, 1%, 0.5%, 0.2%, or 0.1% acidifier.

In some embodiments, the extrudate is substantially free or free of a gluten. In some embodiments, the extrudate comprises, by weight based on the weight of the extrudate on a moisture-free basis, no more than about 2%, 1%, 0.5%, 0.2%, or 0.1% gluten. In some embodiments, the extrudate is substantially free or free of an ingredient derived from an animal (e.g., eggs). In some embodiments, the extrudate comprises, by weight based on the weight of the extrudate on a moisture-free basis, no more than about 2%, 1%, 0.5%, 0.2%, or 0.1% of an ingredient derived from an animal (e.g., eggs). In some embodiments, the extrudate is substantially free or free of an egg white. In some embodiments, the extrudate comprises, by weight based on the weight of the extrudate on a moisture-free basis, no more than about 2%, 1%, 0.5%, 0.2%, or 0.1% egg white.

In some embodiments, the extrudate can further comprise a flavor and/or a spice. In some embodiments, the extrudates resemble chunks of meat, such as irregular chunks, or pieces varying in piece size length between 1-4 cm. In some embodiments, the extrudate has a density of from about 0.30 g/cm³ to about 0.70 g/cm³, or from about 0.30 g/cm³ to about 0.60 g/cm³, or from about 0.30 g/cm³ to about 0.50 g/cm³. In some embodiments, the extrudate has a water binding ratio of at least about 3. In some embodiments, the extrudate has a water binding ratio ranging from about 2 to about 6, or from about 2 to about 5, or from about 3 to about 5, or from about 3 to about 6.

The term “macrostructural fibrous elements”, as used herein, means the meat-like strands, sheets and chunks that are formed during the process of extrusion by the plant protein with assistance from the hydrocolloids. The term “strands”, as used herein, means macrostructural fibrous element strands, especially protein strands, formed in the process of extruding a protein material, generally by protein-protein interactions. Without wishing to be bound by the theory, it is believed that the protein-protein interactions are such that the proteins interact or attach themselves in a head to tail, or head to head, or tail to tail fashion. The protein-protein interactions are such that the proteins interact or attach themselves in a side to side fashion, but to a smaller degree than in protein sheets. The physical size of the protein strands from dry-extrudate pieces with OOBR (object-oriented bounding rectangle) average dimensions of about 3 cm length by about 2 cm width is generally greater than about 1 cm in length or ⅓ the dry-extrudate piece OOBR length. The width of the protein strands is generally from less than about 0.2 cm up to about 1 cm wide. The thickness of the protein strands is generally less than about 0.2 cm.

The term “sheets”, as used herein, means macrostructural fibrous element sheets, especially soy protein sheets, also formed in the process of extruding a soy protein material, again generally by protein-protein interactions. The protein-protein interactions are such that the proteins interact or attach themselves in a head to tail, or head to head, or tail to tail fashion. The protein-protein interactions are such that the proteins interact or attach themselves in a side to side fashion, but to a larger degree than in protein strands. The physical size of the protein sheets from hydrated extrudate pieces with OOBR average dimensions of about 3 cm length by about 2 cm width before hydration are generally greater than about 1 cm in length or ⅓ the dry-extrudate piece OOBR length. The width of the protein sheets is generally greater than about 1 cm wide. The thickness of the protein sheets is generally less than about 0.2 cm.

The term “chunks”, as used herein, means macrostructural fibrous element chunks, especially protein chunks, also formed in the process of extruding a protein material, again generally by protein-protein interactions. The protein-protein interactions are such that the proteins interact or attach themselves in a head to tail, or head to head, or tail to tail fashion, but to a smaller degree than in protein strands. The protein-protein interactions are such that the proteins interact or attach themselves in a side to side fashion, but to a larger degree than in protein strands. The physical size of the protein chunks from hydrated extrudate pieces with OOBR average dimensions of about 3 cm length by about 2 cm width before hydration are generally greater than about 1 cm in length and less than 2 cm in length or ⅔ the dry-extrudate piece OOBR length. The width of the protein chunks is generally greater than about 1 cm or ½ the dry-extrudate piece OOBR width. The thickness of the protein chunks is generally greater than 0.2 cm and less than about 1 cm or ½ the dry-extrudate piece OOBR width.

In some embodiments, the extrudate (dry or hydrated) comprises macrostructural fibrous elements (i.e., strands, sheets and chunks) that are substantially aligned; and/or wherein the arrangement of the macrostructural fibrous elements are such that an average of at least 55% of these fibrous elements in the extrudate are contiguous to each other at less than a 45° angle when viewed in a horizontal plane; and/or which the hydrated extrudate is characterized by average shear strength of at least 1400 grams; and/or which dry extrudate has a density of about 0.30 g/cm³ to about 0.70 g/cm³; and/or which hydrated extrudate has a shred characterization of at least 15% pieces of 2.5 cm in length or greater.

It is to be understood that the combination of the ingredients of the formulation and in particular the combination of plant protein and hydrocolloid in the extrusion process will enable the production of a structured protein product (i.e., extrudate) comprising protein fibers that are substantially aligned into macrostructural fibrous elements in a manner similar to animal meat.

The term “substantially aligned”, as used herein in connection with the arrangement of plant protein fibers or macrostructural fibrous elements, means that the plant protein fibers or macrostructural fibrous elements present in the extrudate (dry or hydrated) are contiguous to each other at less than approximately a 45° angle when viewed in a horizontal plane. Typically, the extrudate (dry or hydrated) comprises plant protein fibers that are substantially aligned, and an average of at least 55% of the plant protein fibers present in the extrudate (dry or hydrated) are substantially aligned. In another embodiment, an average of at least 60% of the plant protein fibers present in the extrudate (dry or hydrated) are substantially aligned. In a further embodiment, an average of at least 70% of the plant protein fibers present in the extrudate (dry or hydrated) are substantially aligned. In an additional embodiment, an average of at least 80% of the plant protein fibers present in the extrudate (dry or hydrated) are substantially aligned. In yet another embodiment, an average of at least 90% of the plant protein fibers present in the extrudate (dry or hydrated) are substantially aligned. Methods for determining the degree of protein fiber alignment are known in the art and include visual determinations based upon micrographic images.

### Dry-Blend Composition

The present disclosure also provides a dry-blend composition (formulation) suitable to be used in the extrusion processes of this disclosure, such as low-moisture extrusion, to make the extrudates of this disclosure. The dry-blend composition comprises, by weight based on the total weight of the dry-blend composition on a moisture-free basis, (a) from about 65% to about 98% plant protein material; (b) from about 1% to about 10% hydrocolloid, wherein the hydrocolloid is selected from the group consisting of alginate, pectin, agar, methylcellulose, and mixtures thereof; and (c) optionally, no more than about 14% starch. The dry-blend composition is a dry blend of its components or ingredients. The dry-blend composition typically comprises, by weight based on the total weight of the dry-blend composition on a moisture-free basis, at least about 60%, 70%, 75%, 80%, or 85% plant protein such as soy protein.

The dry-blend composition comprises, by weight based on the total weight of the dry-blend composition on a moisture-free basis, from about 65% to about 98%, or from about 70% to about 95%, or from about 75% to about 94%, or from about 80% to about 94% plant protein material. In some embodiments, the dry-blend composition comprises, by weight based on the total weight of the dry-blend composition on a moisture-free basis, at least about 65%, 67%, 69%, 71%, 73%, 75%, 77%, 79%, 81%, 83%, 85%, or 86% plant protein material. In some embodiments, the dry-blend composition comprises, by weight based on the total weight of the dry-blend composition on a moisture-free basis, no more than about 98%, 97%, 96%, 95%, 94%, 93%, 92%, 91%, 90%, 89%, or 88% plant protein material. In some embodiments, the plant protein material is a soy protein material. In some embodiments, the soy protein material is selected from the group consisting of soy protein isolate, soy protein concentrate, and combinations thereof. In some embodiments, the soy protein material is a soy protein isolate. In some embodiments, the dry-blend composition comprises, by weight based on the total weight of the dry-blend composition on a moisture-free basis, no more than 3%, 2%, or 1% oil.

In some embodiments, the dry-blend composition comprises, by weight based on the total weight of the dry-blend composition on a moisture-free basis, no more than about 20%, 16%, 14%, 13%, 12%, 11%, 10%, 9%, 8%, 7%, or 6% starch. In some embodiments, the dry-blend composition comprises, by weight based on the total weight of the dry-blend composition on a moisture-free basis, at least about 0.001%, 0.01%, 0.1%, 0.5%, 1%, 2%, 3%, 4%, or 5% starch. In some embodiments, the dry-blend composition comprises, by weight based on the total weight of the dry-blend composition on a moisture-free basis, from about 1% to about 14%, or from about 1% to about 10%, or from about 2% to about 10%, or from about 2% to about 9%, or from about 3% to about 8% starch.

The dry-blend composition comprises, by weight based on the total weight of the dry-blend composition on a moisture-free basis, from about 1% to about 10%, or from about 1% to about 8%, or from about 1% to about 7%, or from about 2% to about 6% hydrocolloid. In some embodiments, the dry-blend composition comprises, by weight based on the total weight of the dry-blend composition on a moisture-free basis, at least about 1%, 1.5%, 2%, 2.5%, 3%, 3.5%, or 4% hydrocolloid. In some embodiments, the dry-blend composition comprises, by weight based on the total weight of the dry-blend composition on a moisture-free basis, no more than about 10%, 9%, 8%, 7%, 6.5%, 6%, 5.5%, 5%, 4.5% or 4% hydrocolloid. In some embodiments, the hydrocolloid is an alginate selected from the group consisting of calcium alginate, potassium alginate, sodium alginate, and combinations thereof. In some embodiments, the hydrocolloid is calcium alginate. In some embodiments, the hydrocolloid is sodium alginate. In some embodiments, the hydrocolloid is a mixture of sodium alginate and calcium alginate.

In some embodiments, the hydrocolloid comprises, consists essentially of or consists of an alginate, and the dry-blend composition further comprises a calcium-containing compound. In some embodiments, the calcium-containing compound is selected from the group consisting of calcium alginate, calcium sulphate, calcium carbonate, calcium phosphate, di-calcium phosphate, calcium chloride, (encapsulated) calcium lactate, and mixtures thereof. In some embodiments, the calcium-containing compound is a sparingly soluble calcium compound. In some embodiments, the dry-blend composition comprises, by weight based on the total weight of the dry-blend composition on a moisture-free basis, from about 0.1% to about 10%, or from about 0.2% to about 8%, or from about 0.5% to about 6%, or from about 1% to about 5% sparingly soluble calcium compound. In some embodiments, the dry-blend composition comprises, by weight based on the total weight of the dry-blend composition on a moisture-free basis, at least about 0.05%, 0.1%, 0.2%, 0.3%, 0.4%, 0.5%, 0.6%, 0.7%, 0.8%, 0.9%, 1%, 1.2%, 1.5%, 1.8%, or 2% sparingly soluble calcium compound. In some embodiments, the dry-blend composition comprises, by weight based on the total weight of the dry-blend composition on a moisture-free basis, no more than about 10%, 9%, 8%, 7%, 6%, 5%, 4%, 3%, or 2% sparingly soluble calcium compound. In some embodiments, the sparingly soluble calcium compound is selected from the group consisting of calcium sulphate, di-calcium phosphate, calcium carbonate, and mixtures thereof.

In some embodiments, both the hydrocolloid and the calcium-containing compound are calcium alginate, and the dry-blend composition comprises, by weight based on the total weight of the dry-blend composition on a moisture-free basis, from about 1% to about 10%, or from about 2% to about 8%, or from about 4% to about 6% calcium alginate. In some embodiments, the dry-blend composition comprises, by weight based on the total weight of the dry-blend composition on a moisture-free basis, at least about 0.5%, 1%, 2%, 3%, or 4% calcium alginate. In some embodiments, the dry-blend composition comprises, by weight based on the total weight of the dry-blend composition on a moisture-free basis, no more than about 15%, 12%, 10%, 9%, 8%, 7%, or 6% calcium alginate.

In some embodiments, the hydrocolloid is a pectin (e.g., pectin having an averaged DE of at least 50), and the dry-blend composition is substantially free or free of a calcium-containing compound such as a sparingly soluble calcium compound. In some embodiments, the dry-blend composition comprises, by weight based on the total weight of the dry-blend composition on a moisture-free basis, no more than about 0.5%, 0.4%, 0.3%, 0.2%, 0.1%, 0.08%, 0.05%, 0.02%, or 0.01% calcium-containing compound.

In embodiments wherein the dry-blend composition comprises alginate and a calcium-containing compound such as a sparingly soluble calcium compound, optionally the dry-blend composition further comprises a sequestrant or an acidifier. In some embodiments, the dry-blend composition comprises a sequestrant. In some embodiments, the dry-blend composition comprises a sequestrant selected from the group consisting of tetra sodium pyrophosphate (TSPP), trisodium phosphate (TSP), disodium phosphate (DSP), sodium-hexametaphosphate (SHMP), trisodium citrate, and mixtures thereof. In some embodiments, the dry-blend composition comprises an acidifier. In some embodiments, the dry-blend composition comprises glucono delta-lactone (GDL) as the acidifier.

The amount of sequestrant present in the dry-blend composition is typically less than the stoichiometric amount to bind the calcium ions present in the dry-blend composition as calcium-containing compound such as sparingly soluble calcium compound. In some embodiments, the amount of sequestrant present in the dry-blend composition ranges from about 20% to about 85%, or from about 30% to about 80%, or from about 40% to about 75%, or from about 50% to about 75% of the stoichiometric amount. By “stoichiometric amount (of sequestrant)” it is meant the amount of sequestrant needed to bind the amount of calcium ions present in the dry-blend composition. In some embodiments, the amount of sequestrant present in the dry-blend composition is at least about 10%, 20%, 30%, 40%, 50%, 60%, or 70% of the stoichiometric amount. In some embodiments, the amount of sequestrant present in the dry-blend composition is no more than about 90%, 85%, 80%, 75%, 70%, or 65% of the stoichiometric amount.

In some embodiments, the dry-blend composition comprises, by weight based on the total weight of the dry-blend composition on a moisture-free basis, from about 0.1% to about 10%, or from about 0.2% to about 8%, or from about 0.4% to about 5%, or from about 0.5% to about 3% acidifier. In some embodiments, the dry-blend composition comprises, by weight based on the total weight of the dry-blend composition on a moisture-free basis, at least about 0.05%, 0.1%, 0.2%, 0.3%, 0.4%, 0.5%, 0.6%, 0.7%, or 0.8% acidifier. In some embodiments, the dry-blend composition comprises, by weight based on the total weight of the dry-blend composition on a moisture-free basis, no more than about 15%, 12%, 10%, 9%, 8%, 7%, 6%, 5%, 4%, 3%, or 2% acidifier. In some embodiments, the acidifier is glucono delta-lactone (GDL).

In some embodiments, the dry-blend composition consists essentially of or consists of, by weight based on the total weight of the dry-blend composition on a moisture-free basis, (a) from about 81% to about 94% soy protein isolate; (b) from about 1% to about 5% alginate such as sodium alginate and/or potassium alginate; (c) from about 1% to about 10%, or from about 2% to about 8% starch, such as tapioca starch; (d) from about 1% to about 10%, or from about 1% to about 8%, or from about 1% to about 6%, or from about 1% to about 4% calcium-containing compound selected from the group consisting of calcium carbonate, calcium alginate, calcium sulphate, and mixtures thereof; and (e) from about 1% to about 3% fiber. In this disclosure, the claimed dry-blend composition possess the basic and novel characteristic(s) of being able to form the extrudates of this disclosure through an extrusion process.

In some embodiments, the dry-blend composition comprises, consists essentially of or consists of, by weight based on the total weight of the dry-blend composition on a moisture-free basis, (a) from about 82% to about 94%, or from about 84% to about 92% soy protein isolate; (b) from about 1% to about 5%, or from about 2% to about 4% alginate such as sodium alginate and/or potassium alginate; (c) from about 2% to about 10%, or from about 3% to about 8% starch such as tapioca starch; (d) from about 0.3% to about 3%, or from about 0.5% to about 2% calcium carbonate; and (e) optionally, from about 0.3% to about 3%, or from about 0.5% to about 2% glucono delta lactone (GDL).

In some embodiments, the dry-blend composition comprises, consists essentially of or consists of, by weight based on the total weight of the dry-blend composition on a moisture-free basis, (a) from about 80% to about 96%, or from about 84% to about 94%, or from about 88% to about 92% soy protein isolate; (b) from about 2% to about 10%, or from about 3% to about 8%, or from about 4% to about 6% calcium alginate; and (c) from about 2% to about 10%, or from about 3% to about 8%, or from about 4% to about 6% starch such as tapioca starch. In some embodiments, such dry-blend composition is free of a sequestrant and/or an acidifier. It has been surprisingly discovered through experiments that calcium alginate alone can be used as a gelling agent in the extrusion process of this disclosure to produce extrudates having similar texture as extrudates produced with the gelling system of “sparingly soluble calcium compound+sodium or potassium alginate+sequestrant or acidifier”. Such extrudates also possess improved features in terms of sensory characteristics of an irregular external shape and irregular internal structure mimicking the appearance of non-fabricated natural structured foods for meat.

In some embodiments, the dry-blend composition comprises, consists essentially of or consists of, by weight based on the total weight of the dry-blend composition on a moisture-free basis, (a) from about 75% to about 90%, or from about 80% to about 90% soy protein isolate; (b) from about 3% to about 8%, or from about 4% to about 6% alginate such as sodium alginate and/or potassium alginate; (c) from about 3% to about 8%, or from about 4% to about 6% starch such as tapioca starch; (d) from about 1% to about 7%, or from about 2% to about 5% calcium sulphate (hydrated or anhydrous); and (e) from about 0.7% to about 3%, or from about 1% to about 2.5% sequestrant selected from the group consisting of tetrasodium pyrophosphate (TSPP), trisodium phosphate (TSP), disodium phosphate (DSP), sodium hexametaphosphate (SHMP), and mixtures thereof.

In some embodiments, the dry-blend composition further comprises, by weight based on the total weight of the dry-blend composition on a moisture-free basis, no more than about 6%, 5%, 4%, 3% or 2% added fiber ingredient. In some embodiments, the dry-blend composition further comprises, by weight based on the total weight of the dry-blend composition on a moisture-free basis, at least about 0.5%, 1%, 2%, 3%, 4%, or 5% added fiber ingredient. In some embodiments, the added fiber ingredient is a citrus fiber.

The dry-blend composition is dry. In some embodiments, the dry-blend composition has a moisture content of no more than about 10 wt %, 8 wt %, 6 wt %, 4 wt %, 2 wt %, or 1 wt % based on the total weight of the dry-blend composition. In some embodiments, the dry-blend composition has a moisture content of from about 1 wt % to about 10 wt %, or from about 2 wt % to about 6 wt % based on the total weight of the dry-blend composition.

In some embodiments, the dry-blend composition is substantially free or free of sulphate ions. In some embodiments, the dry-blend composition comprises, by weight based on the total weight of the dry-blend composition on a moisture-free basis, no more than about 2%, 1%, 0.5%, 0.2%, or 0.1% sulphate ions. In some embodiments, the dry-blend composition is substantially free or free of phosphate ions. In some embodiments, the dry-blend composition comprises, by weight based on the total weight of the dry-blend composition on a moisture-free basis, no more than about 2%, 1%, 0.5%, 0.2%, or 0.1% phosphate ions.

In some embodiments, the dry-blend composition is substantially free or free of a starch. In some embodiments, the dry-blend composition comprises, by weight based on the total weight of the dry-blend composition on a moisture-free basis, no more than about 2%, 1%, 0.5%, 0.2%, or 0.1% starch. In some embodiments, the dry-blend composition is substantially free or free of fibers. In some embodiments, the dry-blend composition comprises, by weight based on the total weight of the dry-blend composition on a moisture-free basis, no more than about 2%, 1%, 0.8%, 0.7%, 0.6%, 0.5%, 0.2%, or 0.1% fibers.

In some embodiments, the dry-blend composition is substantially free or free of a pectin. In some embodiments, the dry-blend composition comprises, by weight based on the total weight of the dry-blend composition on a moisture-free basis, no more than about 2%, 1%, 0.5%, 0.2%, or 0.1% pectin. In some embodiments, the dry-blend composition is substantially free or free of a sequestrant. In some embodiments, the dry-blend composition comprises, by weight based on the total weight of the dry-blend composition on a moisture-free basis, no more than about 2%, 1%, 0.5%, 0.2%, or 0.1% sequestrant. In some embodiments, the dry-blend composition is substantially free or free of an acidifier. In some embodiments, the dry-blend composition comprises, by weight based on the total weight of the dry-blend composition on a moisture-free basis, no more than about 2%, 1%, 0.5%, 0.2%, or 0.1% acidifier.

In some embodiments, the dry-blend composition is substantially free or free of a gluten. In some embodiments, the dry-blend composition comprises, by weight based on the total weight of the dry-blend composition on a moisture-free basis, no more than about 2%, 1%, 0.5%, 0.2%, or 0.1% gluten. In some embodiments, the dry-blend composition is substantially free or free of an ingredient derived from an animal (e.g., eggs). In some embodiments, the dry-blend composition comprises, by weight based on the total weight of the dry-blend composition on a moisture-free basis, no more than about 2%, 1%, 0.5%, 0.2%, or 0.1% of an ingredient derived from an animal (e.g., eggs).

### Extrusion Process

The dry-blend composition is suitable for mixing with water to form a feed mixture suitable for extrusion. The present disclosure also provides an extrusion process to make the extrudates of this disclosure. The extrusion process comprises: (a) contacting the dry-blend composition of this disclosure with water to form a feed mixture; (b) feeding the feed mixture into an extruder to form a molten extrusion mass; and (c) extruding the molten extrusion mass through an extrusion die to produce an extrudate. In some embodiments, the extrusion process is a low-moisture extrusion process. In some embodiments, the extrudate produced in step (c) is further dried.

In some embodiments, components (i.e., ingredients) of a dry-blend composition are introduced into a mixing tank to combine and mix the components to form the dry-blend composition. The dry-blend composition is then transferred to a hopper from which the dry-blend composition is introduced along with moisture into a pre-conditioner to form a feed mixture. The feed mixture is then fed to an extrusion apparatus (i.e., extruder) in which the feed mixture is processed under mechanical pressure generated by the screws of the extruder to form a molten extrusion mass. The molten extrusion mass exits the extruder through an extrusion die to form an extrudate. In some embodiments, the molten extrusion mass exits the extrusion die in a non-contiguous manner. In some embodiments, the molten extrusion mass is shaped by the die configuration as it exits and is cut with rotating blades. In some embodiments, the extrudates' shape and dimensions are formed by increasing the shear rate of the extruder to create the non-contiguous manner and/or adjusting the cutter speed of the rotating blades.

### Hydrating Process and Hydrated Extrudate

The present disclosure also provides a process of preparing a hydrated extrudate. The process comprises hydrating the extrudate of this disclosure in an aqueous solution such as water to form the hydrated extrudate. As is employed herein, the terms “hydrated” or “rehydrated” when applied to extrudate means an extrudate, optionally dry, being hydrated or rehydrated in an aqueous solution comprising water. In some embodiments, the aqueous solution comprises at least about 80%, 85%, 90%, 92%, 94%, 95%, 96%, 97%, 98%, or 99% water based on the weight of the aqueous solution. In some embodiments, the aqueous solution is water. In some embodiments, the aqueous solution further comprises a spice and/or a flavor. In some embodiments, the extrudate is dried before the hydrating step.

In some embodiments, the hydrating process is conducted by hydrating about one weight part of extrudate (e.g., dry-extrudate) in about three weight parts of an aqueous solution. The hydrating process can be conducted under atmospheric pressure or under vacuum. In some embodiments, the hydrating process is conducted under vacuum, such as under about 20% to about 100% vacuum (about −0.2 bar to about −1 bar), or under about 20% to about 50% vacuum (about −0.2 bar to about −0.5 bar), or under no more than about 50% vacuum (about −0.5 bar), or under at least about 20% vacuum (about −0.2 bar).

In some embodiments, the hydration time (duration of the hydrating process) is from about 30 min (minutes) to about 180 min, or from about 60 min to about 120 min, or from about 90 min to about 120 min. In some embodiments, the hydrating process is conducted by soaking the extrudate in an aqueous solution. In some embodiments, the extrudate can be hydrated by adding 3 weight parts of water and one weight part of extrudate into a vacuum bag which is then sealed on vacuum packager such as a Webomatic vacuum packer. The sealed bag is shaken and flipped frequently throughout the whole hydration period to ensure uniform hydration.

Typical shelf-stable structured plant protein products require re-hydration and generally are uniform for the final application. These products present spongy texture during re-hydration; this characteristic presents negative sensorial attributes for final meat alternative applications. This issue presents challenges and will require further process and re-formulation to eliminate the airy texture and improve the overall texture to mimic whole muscle products; in addition, these products need to be shaped to meet the final applications appearance and sensorial attributes.

The present disclosure provides the description and composition of extrudates which are shelf stable structured plant protein products irregular in shape. When the extrudate of this disclosure is (re)hydrated with water, flavors and/or colors, the generated hydrated extrudate is a ready-to-use meat-alternative food product which has similar appearance to whole muscle products such as chunks, dices, cubes, shreds, strips, etc.

The term “dry-extrudate”, as used herein, means the extrudate (e.g., low-moisture extrudate) after drying and prior to hydration or rehydration. A “dry-extrudate” may herein sometimes simply be referred to as an extrudate or low-moisture extrudate. Typically a dry-extrudate has a moisture content of less than about 12 wt %, preferably less than about 10 wt %, based on the total weight of the extrudate.

In some embodiments, the hydrated extrudate comprises at least about 15 wt % of fragments comprised of macrostructural fibrous elements comprising strands of at least about 1 cm long or ⅓ the length of the dry-extrudate, and/or sheets of at least about 1 cm long or ⅓ the length of the dry-extrudate and which sheets are at least 1 cm wide or ½ the width of the dry-extrudate, and/or chunks of at least about 1 cm long or ⅓ the length of the dry-extrudate, of at least 1 cm wide or ½ the width of the dry-extrudate and of up to 1 cm thick or ½ the thickness of the dry-extrudate.

The total amount of strands, sheets and chunks can be determined by the shred characterization test in which they appear as “large pieces”. In some embodiments, the hydrated extrudate comprises from about 20 wt % to about 70 wt %, or from about 22 wt % to about 65 wt %, or about 24 wt % to about 60 wt %, or about 40 wt % to about 65 wt %, or about 45 wt % to about 60 wt % macrostructural fibrous elements (strands, sheets and chunks) based on the weight of the hydrated extrudate. In some embodiments, the hydrated extrudate comprises at least about 15 wt %, 20 wt %, 22 wt %, 24 wt %, 26 wt %, 28 wt %, 30 wt %, 32 wt %, 34 wt %, 36 wt %, 38 wt %, 40 wt %, 42 wt %, 44 wt %, 46 wt %, or 48 wt % macrostructural fibrous elements (strands, sheets and chunks) based on the weight of the hydrated extrudate. In some embodiments, the hydrated extrudate comprises no more than about 75 wt %, 70 wt %, 68 wt %, 66 wt %, 64 wt %, 62 wt %, 60 wt %, 58 wt %, 56 wt %, or 54 wt % macrostructural fibrous elements (strands, sheets and chunks) based on the weight of the hydrated extrudate.

In some embodiments, the hydrated extrudate has average shear strength of at least about 1400 grams, such as at least about 1500, 1600, 1700, 1800, 1900, 2000, 2200, 2400, 2600, 2800, 3000, 3200, 3400, 3600, or 3800 grams. In some embodiments, the hydrated extrudate has average shear strength of no more than about 6000, 5500, 5000, 4800, 4600, 4400, 4200, 4100, 4000, or 3900 grams. In some embodiments, the hydrated extrudate has average shear strength ranging from about 2000 to about 5500 grams, or from about 2500 to about 5000 grams, or from about 3000 to about 4500 grams.

Many aspects and embodiments have been described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims.

### Analytical Methods and Terms

The term “density”, as used herein, means a density determined by the displacement of salt method as described below. All length measurements are in millimeters (mm), all volume measurements are in milliliters (ml) and all weight measurements are in grams (g). The salt is granular table salt having the following particle size distribution:

| US Mesh | Typical % Retained on Screen |
|---|---|
| 30 | 2 (10 max) |
| 40 | 37 |
| 50 | 52 |
| 60 | 3 |
| 70 | 1 |
| Pan | (10 max) |

Using a vessel having a known volume and known weight (tare), add the table salt (density of from about 1.29 g/cm³ up to about 1.40 g/cm³) to a depth of about 5 mm. Add a known weight amount of the extrudate on top of the salt, but not touching the walls of the vessel. Add table salt to the vessel to the point of overflow, tap the filled vessel on the table to pack the salt around the extrudate and using a spatula to level the salt flat with the rim of the vessel. Record the weight of the filled vessel and subtract out the weight of the extrudate and the tare weight to give the weight of the salt in the filled vessel. Divide the weight of the salt by its density to give the volume of salt in the filled vessel. From the known volume of the vessel, subtract the volume of salt to give the volume of the extrudate in the vessel. Divide the weight of the extrudate by the volume of the extrudate to obtain its density in g/cm³.

The term “water binding ratio”, as used herein, means the amount of water that the extrudate can hold or bind in a 60 minutes hydration process at room temperature.

Accordingly, it is a ratio described as (mass of water held)/(mass of extrudate). The water binding ratio at 60 minutes hydration time is determined by the following procedure: weigh about 10 to 15 pieces of a dried extrudate sample [W1] and hydrate the extrudate sample with sufficient water (e.g., 7 parts water to 1 part extrudate sample) at room temperature so that the extrudate sample is fully submerged under the water during the entire 60 minutes hydration process. During the hydration, the extrudate sample can be held submerged under the water with a suitable matter such as a container of water. After hydration, the hydrated extrudate sample is drained for at least 10 seconds and up to 1 minute over a US Mesh #8 (2.38 mm) or #10 (2.00 mm) 8″×2″ sieve and then weighed [W2]. The water binding ratio is [(W2-W1)/W1].

The term “moisture content”, as used herein, means the amount of moisture in a material. The moisture content can be determined by A.O.C.S. (American Oil Chemists Society) Official Method Ba 2a-38 (1997), which is incorporated herein by reference in its entirety for all purposes. According to the method, the moisture content of a material may be measured by passing a 1000 g sample of the ground material through a 6×6 riffle divider, available from Seedboro Equipment Co., Chicago, Illinois, and reducing the sample size to 100 g. The 100 g sample is then immediately placed in an airtight container and weighed. Five grams of the sample (“Sample Weight”) are weighed onto a tared moisture dish (minimum 30 gauge, approximately 50×20 millimeters, with a tight-fitting slip cover—available from Sargent-Welch Co.). The dish containing the sample is placed in a forced draft oven and dried at 130±3 ºC for 2 hours. The dish is then removed from the oven, covered immediately, and cooled in a desiccator to room temperature. The dish is then weighed to obtain a Dry Weight. Moisture content is calculated according to the formula: Moisture content (%)=100×[(Sample Weight−Dry Weight)/Sample Weight].

The term “calcium content”, as used herein, means the amount of elemental calcium in a material, by weight based on the weight of the material on a moisture-free basis. The terms “calcium” and “calcium ions” can be used interchangeably in this disclosure. The amount of elemental calcium in a material can be determined by ICP Emission Spectrometry (ICP-OES) using variations of Official Methods of Analysis of AOAC INTERNATIONAL, Method 984.27, 985.01, and 2011.14 (AOAC INTERNATIONAL, Gaithersburg, MD, USA), which are incorporated herein by reference in their entireties for all purposes. Samples are either dry ashed, wet ashed, or read directly. If dry ashed, the sample is placed in a muffle furnace set to maintain 500° C. until ashing is complete. The resulting ash is treated with concentrated hydrochloric acid, dried and re-dissolved in hydrochloric acid solution. If wet ashed, the sample is digested in a microwave or on a hot plate with nitric acid, hydrochloric acid, and/or hydrogen peroxide. The amount of elemental calcium is determined with an ICP spectrometer by comparing the emission of the sample against the emission of elemental calcium from standard solutions.

“Protein content” or “amount of protein” (e.g., soy protein content or amount of soy protein) in a material can be measured according to A.O.C.S. (American Oil Chemists Society) Official Methods Bc 4-91(1997), Aa 5-91(1997), or Ba 4d-90(1997), each incorporated herein by reference in its entirety for all purposes, which determine the total nitrogen content of a material sample as ammonia, and the protein content as 6.25 times the total nitrogen content of the sample.

The Nitrogen-Ammonia-Protein Modified Kjeldahl Method of A.O.C.S. Official Methods Bc 4-91 (1997), Aa 5-91 (1997), and Ba 4d-90(1997) used in the determination of the soy protein content may be performed as follows with a powder or ground soy material sample. From 0.0250-1.750 grams of the soy material are weighed into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, then 30 milliliters of concentrated sulfuric acid is added to the flask. Boiling stones are added to the mixture, and the soy material sample is digested by heating the flask in a boiling water bath for approximately 45 minutes. The flask should be rotated at least 3 times during the digestion. Water (300 milliliters) is added to the sample in the flask, and the sample is cooled to room temperature. Standardized 0.5 N hydrochloric acid and distilled water are added to a distillate receiving flask sufficient to cover the end of a distillation outlet tube at the bottom of the receiving flask. Sodium hydroxide solution is added to the digestion flask in an amount sufficient to make the digestion solution strongly alkaline. The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected. The contents of the receiving flask are then titrated with 0.25 N sodium hydroxide solution using 3 or 4 drops of methyl red indicator solution—0.1% in ethyl alcohol. A blank determination of all the reagents is conducted simultaneously with the sample and similar in all respects, and correction is made for blank determined on the reagents. The nitrogen content of the sample is determined according to the formula: Nitrogen (%)=1400.67×[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample.

The term “piece size”, as used herein, means the 2-dimensional measurements of length, width and area of the irregular shaped pieces as presented to a MultiSpectral imaging analyzer system that integrates illumination, camera, and computer technology with advanced digital image analysis and statistics. A suitable MultiSpectral imaging analyzer system used to perform these measurements is a model VideometerLab 4 developed and manufactured by Videometer A/S (Denmark). The extrudate samples (dry or hydrated) were randomly placed 3 pieces to a petri dish without touching and presented to the VideometerLab for imaging and image processing. The piece size is given as length, width and area for each individual piece. Area is measured as the number of pixels in the piece times the area of a pixel, the latter originating from calibration of the camera system. Length and width are defined with respect to the object-oriented bounding rectangle (OOBR) of the piece, where object orientation is defined as the eigenvector orientation of the first principal component. Each extrudate sample had 5 different petri dishes imaged for a total of 15 pieces and the average piece size dimension results are reported.

The term “shear strength” as used herein measures the ability of a textured protein to form a fibrous network with a strength high enough to impart meat-like texture and appearance to a formed product. Shear strength is measured in grams. The shear strength is determined by the following procedure: Weigh a sample of an extrudate and place it in a heat sealable pouch and hydrate it with 3 times the sample weight of room temperature tap water. Evacuate to 150 mm Hg and seal the pouch and permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (USA). A suitable texture analyzer used to perform this test is a model TA.TX.Plus manufactured by Stable Micro Systems Ltd. (England) equipped with a 5, 30, 50, or 100 Kg load cell. Within the context of this test, the shear strength is the maximum force in grams needed to puncture through the sample. Each extrudate sample is run 10 times and the average result is reported.

The term “large pieces”, as used herein, means the macrostructural fibrous elements (i.e., strands, sheets and chunks) present in the extrudates. In a shred characterization test, the shredded extrudate pieces containing macrostructural fibrous elements appear as “large pieces” which have larger physical size than shredded extrudate pieces lacking macrostructural fibrous elements. A hydrated extrudate comprises at least about 15 wt % of large pieces based on the weight of the hydrated extrudate. The large pieces are determined by a shred characterization test. Shred characterization is a test that generally determines the percentage of large pieces formed in the extrudates. Shred characterization provides an additional means to quantify the degree of plant protein fiber alignment in an extrudate. Generally speaking, as the percentage of large pieces increases, the degree of plant protein fibers that are aligned within an extrudate also typically increases. Conversely, as the percentage of large pieces decreases, the degree of plant protein fibers that are aligned within an extrudate also typically decreases.

The procedure for the shred characterization test is as follows: Weigh about 150 g of a dry-extrudate sample using whole pieces only, into a heat-sealable plastic bag and add about 450 g water at 25° C. Vacuum seal the bag at about −150 mm Hg (about 20% vacuum or about −0.2 Bar) and allow the extrudate to hydrate for 60 minutes. Place the hydrated extrudate in the 5 quart bowl of a heavy duty bench top mixer equipped with a single blade flat paddle and mix the hydrated extrudate at 130 rpm for 2 minutes. A suitable mixer used to perform this test is a 325W Kitchen Aid Heavy Duty Mixer model KM14G0 or model Pro 500. Scrape the paddle and the sides of the bowl, returning the scrapings to the bottom of the bowl. Repeat the mixing and scraping 2 times. Remove a 50 to 200 g portion of the mixture from the bowl and weigh it. Separate the mixture into 1 of 5 groups. Group 1 is the strand group wherein the strands are at least 1 cm long and up to 1 cm wide and up to 0.2 cm thick or as defined in this disclosure. Group 2 is the sheet group wherein the sheets are at least 1 cm long and at least 1 cm wide and up to 0.2 cm thick or as defined in this disclosure. Group 3 is the chunk group wherein the chunks are 1 to 2 cm long and 0.5 cm to 1 cm wide and greater than 0.2 cm thick or as defined in this disclosure. Group 4 is mostly intact hydrated extrudate pieces with dimensions greater than chunks. The remaining mixture is Group 5. The percentage of large pieces are determined by adding the weight total of Group 1+Group 2+Group 3, multiplying by 100 and dividing by the total weight of Group 1+Group 2+Group 3+Group 4+Group 5.

The extrudates piece analytical functionality may be characterized further by e.g. X-ray tomography offering visual record of internal structure as well as providing quantitative measure of void space and wall thickness. Magnetic resonance imaging (MRI) is a potential alternative analytical method for hydrated extrudates. Also, microscopy may be used.

### Example 1

Samples of extrudate of this disclosure were produced by low-moisture extrusion process and analyzed and compared with commercially available samples. Samples of extrudate were produced by using the corresponding samples of the dry-blend composition (formulation) as shown in Table 1. The amounts of components (ingredients) in Table 1 are weight percentages based on the total weight of the dry-blend composition on a moisture-free basis.

TABLE 1
Samples of the dry-blend composition for making
the corresponding samples of extrudates

| | Samples of dry-blend composition | | | | |
|---|---|---|---|---|---|
| Components | 1 | 2 | 3 | 4 | 5 |
| Soy protein isolate | 85 | 89 | 90 | 90 | 90 |
| Tapioca starch | 5 | 5 | 5 | 5 | 5 |
| Sodium alginate | 5 | 3 | 1.5 | | |
| Calcium alginate | | | 1.5 | 5 | |
| Calcium sulphate dihydrate | 3.3 | | | | |
| Calcium carbonate | | 1.5 | | | |
| Tetra sodium pyrophosphate | 1.7 | | | | |
| Glucono delta-lactone (GDL) | | 1.5 | | | |
| Citrus fiber | | | 2 | | |
| High-methoxyl pectin | | | | | 5 |
| Total | 100 | 100 | 100 | 100 | 100 |

Two reference samples were used for comparison. Reference 1 is a commercially available low-moisture extrudate containing wheat gluten. Reference 2 is same as Reference 1 except it was produced on the same pilot scale equipment and using the same extrusion process as for Samples 1-5 in Table 1.

Typical low-moisture extrusion process follows these typical steps: Components as listed in Table 1 are dry blended using a blending equipment to form the dry-blend composition which is transported by air conveyed or auger to the stationary bin, then the dry-blend composition is further transported to the feeding bin, typically located above the extruder. The extruder system can be a single or twin extruder with a preconditioner above the inlet of the extruder. The dry-blend composition (dry feed) is introduced into the extruder or preconditioner, and water and/or other liquids can be added directly to the extruder barrel or at both locations if preconditioner is part of the extrusion system. Low moisture extrusion is considered as <40% water or fluids per dry feed ratio (<0.4 parts of water-liquids/1 part of dry feed rate). The total water added between preconditioner and extruder will count as total water ratio. The dry-blend composition is contacted or mixed with water (and optionally other liquids) to form the feed mixture to the extruder.

Moderate to high shear screw configurations profiles are typically used for low-moisture extrusion process, and the amount of energy in the profile is selected according to the final product attributes and components used in the dry-blend composition. After addition of the feed mixture, the extruder typically rotates >200 rpm to achieve sufficient mechanical energy to achieve extrudate temperature to >100° C.; most commonly >120° C. and >100 psi of pressure at the extruder cone head zone to achieve product texturization/expansion. Under the high temperature, high pressure and mechanical shearing, the feed mixture is transformed to a molten extrusion mass in the extruder.

When the molten extrusion mass exits the extrusion die, part of the over-heated and pressurized water is transformed to steam, then it is flushed and forms bubbles that creates the network (honey-comb—airy structure) of the extrudate. Extrudate typically is segmented/cut using a rotatory cutter to provide the proper particle size or dimensions of the final extrudate product. Additional grinders or size reduction equipment can be used after die cutting to achieve the right particle size, forms and structure of the final extrudate product. After sizing the extrudate product is typically air conveyed to a dryer to reduce the moisture content to a shelf stable range, typically to <12 wt % and preferably to <10 wt %.

Extrusion process for the preparation of the samples of extrudate: Components of each sample of dry-blend composition were blended for 30 minutes in a horizontal ribbon blender Model TD415 (DODGE OF Mishawaka, Ind.) with 300 Lb. capacity to form the dry-blend composition which was a uniform mixture of its components. Each dry-blend composition was manually fed to the feeding bin and mechanical conveyed to the extruder hopper, then fed to the preconditioner at 70 KG/Hr. (1.16 Kg/Min). Steam was injected into the preconditioner at 5% dry basis, approximately 3 Kg/Hr. of steam to achieve 45° C.-50° C. downspout preconditioner temperature. This temperature was measured by a thermocouple positioned at the preconditioner discharge end. Water was added into the preconditioner and maintained constant flow at 15 wt % dry base addition rate 10.5 Kg/Hr. (0.18 Kg/Min). The residence time for the dry-blend composition in preconditioner was about 4 minutes wherein the dry-blend composition was contacted or mixed with water to form the feed mixture to the extruder.

Then the preconditioned dry-blend composition (i.e., feed mixture) was fed to the extruder using a transition to prevent leakage, excessive dust and to ensure consistent flow to the extruder. A Wenger TX-52 twin-screw extruder (19/1 L/D ratio) manufactured by Wenger Manufacturing Inc. (Sabetha, KS) was used for the extrusion process. Extruder Barrel temperatures were maintained at the settings: Zone 1 (60° C.-70° C.), Zone 2 (80° C.-100° C.), Zone 3 (120° C.-130° C.), and Zone 4 (120° C.-130° C.). A high shear screw configuration was used to produce the low-moisture extrudates shown in Table 2: Conveying—Inlet, Conveying—Zone 1, Conveying/Mixing and compression—Zone 2, Mixing/Shearing/Compression—Zone 3, and Compression/Mixing/Shearing—Zone 4. During extrusion process water was pumped into the first section of the extruder at 8 wt %-10 wt % dry basis and extruder speed was adjusted between 350-400 rpm to achieve good texturization. Extruder cone head pressure was 200-300 psi, and motor load was 28%-35%.

The molten extrusion mass formed in the extruder was extruded thought an extrusion die. A 2-inch die extension and two 9 mm die inserts each positioned in each side of the extruder screws to form the rope's shape of the extrudates, then at the die exit, 1 flexible blade was co-rotating at 300-500 rpm to achieve the length of the extrudates.

The extrudate product was dried in a continuous single pass Proctor Dryer at 260° F.-270° F. with 20 minutes residence time to achieve <10 wt % final extrudate product moisture content and then packaged to be used for the final meat alternative applications. Analytical results of the final extrudate products are shown in Table 2.

TABLE 2
Analytical characterization of low-moisture extrudates made with
corresponding samples of dry-blend composition in Table 1

| | Low-moisture extrudates | | | | | |
|---|---|---|---|---|---|---|
| Analytical Measurement | Ref. 2 | S. 1 | S. 2 | S. 3 | S. 4 | S. 5 |
| Moisture Content (wt %) | 7.4 | 6.7 | 7.0 | 9.7 | 7.1 | 7.0 |
| Protein Content, db (wt %) | 78.5 | 79.4 | 80.7 | 84.7 | 82.4 | 85.4 |
| Calcium Content, db (wt %) | 0.30 | 0.75 | 0.87 | 0.24 | 0.56 | 0.10 |
| Av. Dry Piece Area (mm²) | 461 | 367 | 410 | 464 | 529 | 441 |
| Av. Dry Piece Length (mm) | 29 | 30 | 30 | 29 | 32 | 32 |
| Av. Dry Piece Width (mm) | 22 | 19 | 19 | 22 | 24 | 22 |
| Av. Dry Piece density (g/cm³) | 0.28 | 0.35 | 0.44 | 0.53 | 0.36 | 0.67 |
| Water Binding Ratio @ 60 minutes | 2.8 | 2.4* | 3.2 | 3.3 | 4.6 | 3.7 |
| Av. Shear Strength (g) | 1670 | 1620 | 3630 | 3620 | 3720 | 3820 |
| Large pieces by shred | 11 | 56 | 26⁺ | 51 | 49 | 26 |
| characterization test (wt %) | | | | | | |

*This sample was slow to hydrate and was not fully hydrated after 60 minutes hydration time with hard spots evident on manipulation in almost all pieces. After 120 minutes hydration time, it had a water binding ratio of 2.89 but was still not fully hydrated with hard spots evident on manipulation in almost all pieces. Overnight hydration of this sample gave a water binding ratio >3.5 similar to other samples of extrudate. In contrast, Reference 2 sample was fully hydrated at 60 minutes and had almost no change in water binding ratio at 120 minutes of hydration time with a value of 2.87.
⁺This sample had an additional 26 wt % in Group 4: mostly intact pieces.
Additional notes:
Ref. 2 means Reference 2 sample; db means dry basis (on a moisture-free basis); Av. means average; S. means Sample.

The analytical characterization of the Reference 2 sample and the Samples 1-5 of extrudates of this disclosure show results in the same range for moisture content, average dry piece area, average dry piece length, and average dry piece width. Samples 1-5 show protein content on dry basis in the same range or up to 6.9 wt % higher comparing with Reference 2 although Reference 2 contains wheat gluten, whereas Samples 1-5 are all gluten free. Samples 1-5 have higher average dry piece density (g/cm³) comparing with the Reference 2 sample. Samples 2-5 show higher water binding ratio at 60 minutes comparing with the Reference 2 sample. Samples 2-5 have more than twice the average shear strength comparing with the Reference 2 sample, indicating that extrudates of Samples 2-5 have stronger fibrous macrostructure and thereby mimick the texture of non-fabricated natural structured foods for meat in a better way than Reference 2. Samples 1-5 have significantly higher content of fibrous macrostructure large pieces comparing with Reference 2 and thereby mimick the texture of non-fabricated natural structured foods for meat in a better way than Reference 2.

### Example 2

Samples of extrudate of this disclosure (Samples 2, 3 and 4) were hydrated and cooked and compared with commercial Reference 1 sample for sensory evaluation. Prior to processing the extrudate into a meal component, hydration is needed to soften the extrudate and make it edible and change the stage from dry form to moist and fibrous. Samples of hydrated extrudate were prepared by hydrating (soaking) the corresponding samples of the dry extrudate in an aqueous solution comprising water and spices and flavors shown in Table 3. The amounts of ingredients in Table 3 are weight percentages based on the total weight of the dry extrudate and the aqueous solution.

TABLE 3
Composition of hydrated low-moisture extrudates

| | Hydrated low-moisture extrudates | | | |
|---|---|---|---|---|
| | Ref. 1 | S. 2 | S. 3 | S. 4 |
| Ingredients | | | | |
| Hydration water | 71.2 | 71.2 | 71.2 | 71.2 |
| Reference 1 sample | 25 | | | |
| Dry extrudate Sample 2 | | 25 | | |
| Dry extrudate Sample 3 | | | 25 | |
| Dry extrudate Sample 4 | | | | 25 |
| Dry spices & flavors: | | | | |
| Chicken Stock Flavor | 1.5 | 1.5 | 1.5 | 1.5 |
| Powder | | | | |
| Yeast extract High- | 0.5 | 0.5 | 0.5 | 0.5 |
| Lyfe ™ 530A | | | | |
| Onion Powder | 0.3 | 0.3 | 0.3 | 0.3 |
| Garlic Powder | 0.2 | 0.2 | 0.2 | 0.2 |
| Pepper, black, ground | 0.1 | 0.1 | 0.1 | 0.1 |
| Modulator Umami Flavor | 0.7 | 0.7 | 0.7 | 0.7 |
| Powder IFF | | | | |
| Salt | 0.5 | 0.5 | 0.5 | 0.5 |
| Total | 100 | 100 | 100 | 100 |

Notes:
Ref. 1 means hydrated Reference 1 sample; S. means Sample.

All dry spices & flavors as given in Table 3 were dispersed in the hydration water with 10% flaked ice using Bamix hand blender at speed 2 until no dry lumps were present and the resulting aqueous solution had obtained a homogeneous appearance. Blending time was approximately 1 min. The dry extrudate and the aqueous solution were combined in tumbler system Simatic into drums with vacuum lid. The tumbler system was located in cooling room with maximum 4° C. temperature. The vacuum lids were attached, and vacuum was applied at −1 bar vacuum pressure (about 100% vacuum). The drums were oriented into each one space with rotating rubber rolls. All drums were started with the same adjustable speed and direction by programming the settings in the control panel: forward rotation setting 30, 7 rpm for 10 min and backward rotation setting 30, 7 rpm for 10 min. This cycle of altering forward and backward rotation continued until all extrudates were fully hydrated. Tumbling/hydration time varied for the different samples and was between 90-120 min. Size of the extrudate affects sensory evaluation outcome. Therefore, the hydrated extrudates were cut with a knife to achieve uniform size (standardized size) for all the different samples.

Cooking process was separated in two sub steps. The first step was flash frying the hydrated extrudate pieces and vegetables separately. Vegetables included ginger and carrots thinly sliced, white cabbage thinly sliced, frozen red/green/yellow pepper, pepper, salt and garlic. Large frying pan Joni Foodline was preheated on setting 3/10 for both available sections. 5% Vegetable rapeseed oil was preheated, and hydrated extrudate was applied to the pan. Frying of each portion was done for 8 minutes, while frequently scraping and turning the pieces to obtain uniform browning. After this, the vegetables were fried under the same settings.

The second step was combining the fried extrudate and vegetables and applying final heat to the dishes. Fried extrudate and vegetables were combined in the ratio 1:2 in gastro trays covered with lids. Final heat was applied in Rational oven at 150° C. for 45 minutes with moisture/dry heat balance of 50%/50%. After final heat was applied, the heat was reduced to 85° C., the lids were still on and kept warm until serving or maximum 3 hours. Cooking process of reference chicken breast was done in the same way as for the extrudate, except that spices & flavors were added without water since chicken did not need hydration.

Nine participants joined the sensory evaluation session. The evaluation session started with an introduction to the participants of study, going through and describing the chicken-like attributes. Participants were given an uncoded sample of the cooked reference chicken breast to become familiar with the morphology, texture and structure of chicken. In this way they could return to the reference and repeat tasting of this whenever needed during the entire evaluation for memory purposes. The cooked Reference 1 sample and the cooked extrudate samples were kept warm and served one at a time in random order, with unrecognizable coding. Participants were requested to evaluate on the scale from 0 to 10 (10 is real chicken breast) how close the Reference 1 and extrudate samples were to the chicken breast reference (taking into consideration the aroma, appearance, flavor and texture). Scores on chicken-like attributes were registered in mobile phone software EyeQuestion scanning a QR code, with no option of changing the score once it has been given. No talking or exchanging comments between the participants were allowed during the session, as each score represented an individual unbiased judgement. Scores were automatically collected and shown in Table 4.

TABLE 4
Scores of Chicken-like attribute

| Sample | Chicken-like attribute score |
|---|---|
| Reference 1 sample | 5.24 |
| Extrudate Sample 2 | 6.26 |
| Extrudate Sample 3 | 6.33 |
| Extrudate Sample 4 | 6.46 |

### Example 3

Samples of extrudate of this disclosure (Samples 1, 2, 3, 4 and 5) were hydrated and compared with References 1 and 2 for sensory (eating experience) evaluation. The extrudate needs to be fully hydrated for reliable evaluation. The extrudate was added into a vacuum bag. Tap water was added into the vacuum bag in a ratio of one part of extrudate to 3 parts of water by weight. After the water was added, the bag was sealed on Webomatic vacuum packer under atmospheric pressure. Post packaging, the bag was shaked and flipped frequently throughout the whole hydration period to ensure uniform hydration. In some occasions, the bag was left in cooler of 4° C. overnight prior to evaluation. Hydration continued and evaluation did not start until every extrudate piece was fully hydrated. Full hydration was determined by pressing randomly around the extrudate pieces through the bag. Full hydration was achieved and the hydration process was complete when no hard spots were located.

Commercial Reference 1 sample was used to enable the sensory evaluation participants to return to the reference for memory purposes. All samples were lined up with sample codings and evaluation began. Procedure of practical evaluation was to put a piece of each sample in the mouth and evaluate the physical characteristics during biting and chewing. The evaluation parameters & vocabulary used for scoring was defined in Table 5 as an overall perception of the general eating experience of each sample compared to the commercial Reference 1 sample that was hydrated under the same conditions. The eating experience can be described as a 360° overall experience, including visual appearance, first bite, chewiness, mouthfeel, cell wall structure, fibrosity, tenderness and piece size. The sum of the overall perception was translated into a 1-10 scale score, where 1 was defined as completely disliked and the score 10 was defined as perfectly cooked chicken meat. An example of defining a score could be a sample demonstrating a nearly perfect eating quality with excellent tenderness, fibrosity, color and size that would have the score of 8. However, if one parameter such as mouthfeel affects the overall score in negative direction, the final score would end up at 7. Scores were collected from participants and shown in Table 6.

TABLE 5
Attribute definition resulting in the attribute overall liking

| Attribute | Description |
|---|---|
| Visual | Look at the sample and investigate the |
| appearance | overall natural meat like appearance. |
| First bite | Bite into a piece, with your front teeth, |
| | and evaluate how well you can bite through |
| | the fibers. |
| Chewiness | Chew a piece with your molars and sense |
| | how many times chewing is needed, before |
| | the sample could be swallowed. |
| Mouthfeel | During chewing, experience if there are any |
| | factors affecting the overall eating experience |
| | like sliminess, dryness etc. |
| Cell wall | During chewing, determine how strong the cell |
| structure | walls/fibers are. Too strong and dry structure |
| | will affect the eating quality in a negative |
| | direction and can be described as tough/non- |
| | matured meat. |
| Fibrosity | Fibrosity can be investigated by pulling the |
| | pieces apart, and by chewing. The overall meat |
| | like fiber appearance is detected and included |
| | in the total score. |
| Tenderness | How well does the pieces chew, does it feel |
| | tough or tender? |
| Piece size | Are the single pieces too big or too small or |
| | suitable for at one-bite mouth size piece? |

TABLE 6
Score of overall liking of cold hydrated extrudate samples

| Samples | Overall liking score |
|---|---|
| Reference 1 sample | 3.5 |
| Reference 2 sample | 2.0 |
| Extrudate Sample 1 | 5.5 |
| Extrudate Sample 2 | 7.0 |
| Extrudate Sample 3 | 7.0 |
| Extrudate Sample 4 | 7.0 |
| Extrudate Sample 5 | 6.0 |

### Example 4

Samples of extrudate of this disclosure (Samples 1, 2, 3, 4 and 5) were hydrated and compared with Reference 2 for sensory evaluation. The extrudate needs to be fully hydrated for reliable evaluation. The extrudate was added into a vacuum bag. Tap water and salt were mixed to form an aqueous solution having salt concentration of 0.45 wt %, and the aqueous solution was added to the vacuum bag in a ratio of one part of extrudate to 3 parts of aqueous solution by weight. After the aqueous solution was added, the bag was sealed on Webomatic vacuum packer under atmospheric pressure. Post packaging, the bag was flipped frequently throughout the first hour and left in cooler of 4° C. overnight prior to heating and evaluation.

Sensory profiles of extrudate Samples 1-5 and Reference 2 were compared using descriptive analysis according to the general guidelines for establishing a sensory profile (ISO-13299, 2016). The sensory evaluation panel consisted of seven trained assessors that were tested, selected and trained according to the general guidelines for the selection, training and monitoring of selected assessors and expert sensory assessors (ISO-8586, 2012). Samples were evaluated outside and inside the oral cavity on the attributes described in Table 7. All attributes were evaluated on an unstructured scale (0-15) with anchors at 1.5 and 13.5 which the assessors were trained to correspond to the extremes within the sample set.

TABLE 7
Sensory Attributes

| Modality | Attribute | Method |
|---|---|---|
| Texture - | Hardness during | Press down on a piece of sample |
| Outside | compression | with the back of the fork and |
| mouth | with a fork | evaluate how hard the sample is. |
| Texture - | Juice released | Press down on a piece of sample |
| Outside | during compression | with the back of the fork and |
| mouth | with a fork | evaluate how much juice is |
| | | released from the sample. |
| Texture - | Hardness at | Evaluate how much force is |
| Inside | first bite | needed to bite through the |
| mouth | | sample with the molars. |
| Texture - | Chewing | Chew a piece of sample 12 times |
| Inside | resistance | between your molars and evaluate |
| mouth | | how much resistance the sample |
| | | offers during chewing. Much = |
| | | the feeling of continuous chewing |
| | | due to tough, elastic and rubber- |
| | | like resistance from the sample. |
| Texture - | Tough | Evaluate how hard it is biting/ |
| Inside | | chewing through the sample and |
| mouth | | break it into two pieces. |
| Texture - | Spongy | Evaluate how spongy the sample |
| Inside | | feels during biting/chewing, i.e. |
| mouth | | how much the sample feels like |
| | | biting/chewing into a wet bath/ |
| | | scrub sponge. |
| Texture - | Dissolvable | Chew a piece of sample and evaluate |
| Inside | | how dissolvable it is in the mouth, |
| mouth | | i.e. how easy it is to prepare the |
| | | sample for swallowing. |

Samples were heated in their vacuum bags using a water bath at 80° C. for 20 minutes. Sample materials were divided into 60 ml beakers and served at 60° C. Each assessor received approximately 20 grams of sample material blind-labelled with 3-digit codes to conceal the sample identity. Samples were served one at a time in random order in three replicates and the assessors evaluated all attributes for each sample. Results given in Table 8 show attribute scores averaged across the seven assessors and three repetitions.

TABLE 8
Attribute Scores

| | Hydrated low-moisture extrudates | | | | | |
|---|---|---|---|---|---|---|
| Attributes | Ref. 2 | S. 1 | S. 2 | S. 3 | S. 4 | S. 5 |
| Hardness by pressure | 5.1 | 8.4 | 10.7 | 7.2 | 7.8 | 8.5 |
| with fork | | | | | | |
| Hardness at first bite | 4.2 | 5.2 | 8.4 | 9.3 | 9.9 | 7.3 |
| Chewiness | 5.4 | 5.5 | 8.9 | 10.4 | 10.1 | 9.0 |
| Tough | 5.8 | 5.7 | 9.4 | 10.6 | 10.8 | 9.4 |
| Spongy | 10.8 | 7.4 | 6.4 | 6.9 | 8.2 | 9.6 |
| Dissolvable | 8.2 | 8.9 | 5.2 | 4.2 | 4.1 | 5.4 |

Notes:
Ref. 2 means hydrated Reference 2 sample; S. means Sample.

Hardness by pressure with fork: The results from the sensory panel evaluation indicate that the extrudate Samples 1, 2, 3, 4 and 5 all resulte in a product that is harder (when pressed with the back of a fork) than the Reference 2 and thereby mimicks the texture of non-fabricated natural structured foods for meat in a better way than Reference 2.
Hardness—first bite: The results from the sensory panel evaluation indicate that the extrudate Samples 1, 2, 3, 4 and 5 all result in a product that is harder at first bite than the Reference 2 and thereby mimicks the texture of non-fabricated natural structured foods for meat in a better way than Reference 2.
Chewiness: The results indicate that all extrudate Samples have similar or higher resistance to chewing with the molars compared to Reference 2. Extrudate Samples 2, 3, 4 and 5 show higher resistance to chewing compared to Reference 2 and thereby mimick the texture of non-fabricated natural structured foods for meat in a better way than Reference 2.
Tough: The results indicate that all extrudate Samples 1-5 are similar or higher in how hard it is to bite through the pieces compared to Reference 2. Extrudate Samples 2, 3, 4 and 5 are all higher in toughness compared to Reference 2 and thereby mimick the texture of non-fabricated natural structured foods for meat in a better way than Reference 2.
Spongy—bite: Extrudate Samples 1, 2, 3, 4 and 5 are all less spongy compared to Reference 2 and thereby mimick the texture of non-fabricated natural structured foods for meat in a better way than Reference 2.
Solubility: Extrudate Samples 2, 3, 4 and 5 are all more dissolvable when chewed and by this meaning easier to prepare for swallowing in the mouth when chewing and thereby mimick the texture of non-fabricated natural structured foods for meat in a better way than Reference 2.

### Example 5

Extrudates of this disclosure were hydrated and cooked, and their textures were analyzed in comparison with chicken (cooked) and Reference 1 (also hydrated and cooked in same ways as extrudates of this disclosure).

Dried low-moisture extrudate sample pieces were weighed and the actual weight recorded (W1). Flavors (masker soy flavor, modulator umami flavor, chicken leg flavor) and salt were dissolved to form a water solution. The sample pieces were placed in a plastic bag containing the water solution, sealed under 20% vacuum and hydrated with the water solution at a ratio of dry sample pieces to water solution of 1:3. Full hydration was assured by turning the bag occasionally and storing it overnight at refrigeration conditions (4° C.). The hydrated sample pieces (333 g) were cooked with 7 g oil. Pan was preheated at high heat setting for 1 min, and samples were cooked for 4 min. Samples were intermittently stirred and turned over to assure even browning.

Chicken was cooked with the following procedure: (1) removed skin, excess fat and sinew from the chicken, cut into extrudate sample like pieces, added the salt and pulled 100% vacuum and left in the fridge overnight; (2) pan was preheated at high heat setting for 1 min, 7 g oil were added, then 500 g chicken cubes were added and fried for 7 min, chicken pieces were intermittently stirred and turned over, preventing over browning of meat surface; (3) pan-fried chicken was placed in fridge to cool; (4) portions of 100 g each were packed in small bags, stored refrigerated until texture analysis measurements.

Prior to texture analysis, samples were reheated in a water bath set to 80° C. for 20 min. Texture analysis were conducted as per the following procedure.

A Texture Analyzer (TA-XT Plus C manufactured by Stable Micro Systems Ltd. (England)) was equipped with an Ottawa Cell that had a bottom plate perforated by 6.5 mm diameter holes for drainage, a 6×6 cm top plate attached to the compression arm of the instrument, and a catch pan. The hydrated sample pieces were evenly distributed over the bottom of the Ottawa Cell chamber and compressed by lowering the top plate at a rate of 1 mm/s (down stroke) until 10 kg of force was reached. This force was maintained on the sample for a 2-minute hold time. After the hold time, the force was removed by raising the top plate with a rate of 1 mm/s (up stroke). The pressed hydrated sample pieces were then removed from the Ottawa Cell and weighed (W3). The pressed hydration ratio (PHR) was determined as follows:

$$PHR = \frac{W 3 - W 1}{W 1}$$

The force curves recorded during the compression experiment were analyzed to obtain the first gradient (Grad1), GradRatio, CreepStrain, and Resilience1. Each measurement was repeated at least 4 times on fresh sample and the average values were calculated. Results (average values) from texture analysis measurements are summarized in Table 9. Metrics where there is a large difference between the Reference 1 and Chicken represent properties which are sensitive to the differences ascertained by sensory evaluations. Henceforth, the properties of relevance are:
1. the first gradient (Grad1), which represents piece stiffness, e.g., resistance to deformation and water expulsion. This corresponds to a sensory experience of hardness of first bite. High values correspond to high hardness of first bite and low values of the first gradient to softer sensory experience of first bite.
2. the ratio of the first and second gradient (Grad2), called GradRatio, representing the relative recovery of the water depleted pieces with regards to the imposed deformation on the wet pieces.
3. the CreepStrain, which is the strain acquired in the 10 kg hold phase of the experiment, representing the piece compliance (irreversible strain of protein scaffold and continued irreversible water loss).
4. Resilience1, represents the work of pieces recovering from deformation relative to the work of compression.

CreepStrain, Grad1, GradRatio, and Resilience1 in Table 9 demonstrated that extrudates of this disclosure (Samples 2 and 4) have texture properties closer to chicken than commercial product Reference 1.

TABLE 9
Texture analysis metrics of the low-moisture extrudates

| Metrics | Units | Sample 2 | Sample 4 | Chicken | Reference 1 |
|---|---|---|---|---|---|
| CreepStrain | % | 3.560 | 3.317 | 5.627 | 2.250 |
| Grad1 | kg/% | 0.835 | 0.874 | 0.688 | 1.273 |
| GradRatio | — | 0.201 | 0.225 | 0.162 | 0.243 |
| Resilience1 | — | 0.22 | 0.216 | 0.188 | 0.243 |
| PHR | — | 2.849 | 2.789 | — | 2.899 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

### EMBODIMENTS

For further illustration, additional non-limiting embodiments of the present disclosure are set forth below.

For example, embodiment 1 is an extrudate, such as a low-moisture extrudate, comprising, by weight based on the weight of the extrudate on a moisture-free basis, (a) from about 60% to about 90% plant protein, such as soy protein and/or pea protein; (b) from about 1% to about 10% hydrocolloid, wherein the hydrocolloid is selected from the group consisting of alginate, pectin, agar, methylcellulose, and mixtures thereof; and (c) optionally, no more than about 14% starch, such as from about 1% to about 14% starch.

Embodiment 2 is an extrudate as set forth in embodiment 1 wherein the hydrocolloid comprises or is an alginate, and the extrudate further comprises calcium ions.

Embodiment 3 is an extrudate as set forth in any of the preceding embodiments, wherein the extrudate comprises at least about 60%, 62%, 64%, 66%, 68%, 70%, 72%, 74%, 76%, 78%, 80%, or 82% plant protein.

Embodiment 4 is an extrudate as set forth in any of the preceding embodiments, wherein the extrudate comprises no more than about 90%, 89%, 88%, 87%, 86%, 85%, 83%, 81%, 79%, 77%, 75%, 73%, or 71% plant protein.

Embodiment 5 is an extrudate as set forth in any of the preceding embodiments, wherein the extrudate comprises at least about 1%, 1.5%, 2%, 2.5%, 3%, 3.5%, or 4% hydrocolloid.

Embodiment 6 is an extrudate as set forth in any of the preceding embodiments, wherein the extrudate comprises no more than about 10%, 9%, 8%, 7%, 6.5%, 6%, 5.5%, 5%, 4.5% or 4% hydrocolloid.

Embodiment 7 is an extrudate as set forth in any of the preceding embodiments, wherein the hydrocolloid comprises or is a combination of sodium alginate and calcium alginate.

Embodiment 8 is an extrudate as set forth in any one of embodiments 1 or 3-6, wherein the hydrocolloid comprises or is a pectin, and the extrudate optionally comprises calcium ions.

Embodiment 9 is an extrudate as set forth in any one of embodiments 1 or 3-6, wherein the hydrocolloid comprises or is an agar.

Embodiment 10 is an extrudate as set forth in any one of embodiments 1 or 3-6, wherein the hydrocolloid comprises or is a methylcellulose.

Embodiment 11 is an extrudate as set forth in any one of embodiments 1 or 3-6, wherein the hydrocolloid is calcium alginate.

Embodiment 12 is an extrudate as set forth in any of the preceding embodiments, wherein the extrudate comprises no more than about 13%, 12%, 11%, 10%, 9%, 8%, 7%, or 6% starch. Embodiment 13 is an extrudate as set forth in any of the preceding embodiments, wherein the extrudate comprises at least about 0.001%, 0.01%, 0.1%, 0.5%, 1%, 2%, 3%, 4%, or 5% starch.

Embodiment 14 is an extrudate as set forth in any of the preceding embodiments, wherein the starch is selected from the group consisting of tapioca starch, wheat starch, potato starch, and combinations thereof.

Embodiment 15 is an extrudate as set forth in any of the preceding embodiments, wherein the extrudate further comprises an added fiber ingredient in an amount of no more than about 6%, 5%, 4%, 3% or 2%.

Embodiment 16 is an extrudate as set forth in any of the preceding embodiments, wherein the extrudate further comprises an added fiber ingredient in an amount of at least about 1%, 2%, 3%, 4%, or 5%.

Embodiment 17 is an extrudate as set forth in embodiments 15 or 16, wherein the added fiber ingredient is selected from the group consisting of soy fiber, citrus fiber, pea fiber, and combinations thereof.

Embodiment 18 is an extrudate as set forth in any one of embodiments 1-7 or 11-17, wherein the extrudate has calcium content of at least about 0.01%, 0.02%, 0.05%, 0.08%, 0.1%, 0.15%, 0.2%, 0.25%, 0.3%, 0.35%, 0.4%, 0.45%, or 0.5%.

Embodiment 19 is an extrudate as set forth in any one of embodiments 1-7 or 11-18, wherein the extrudate has calcium content of no more than about 10%, 8%, 6%, 5%, 4%, 3%, 2%, 1.5%, 1.2%, 1%, 0.9%, 0.8%, 0.7%, or 0.6%.

Embodiment 20 is an extrudate as set forth in any one of embodiments 1-6 or 12-19, wherein the extrudate further comprises a sequestrant selected from the group consisting of tetra sodium pyrophosphate (TSPP), trisodium phosphate (TSP), disodium phosphate (DSP), sodium-hexametaphosphate (SHMP), trisodium citrate, and mixtures thereof.

Embodiment 21 is an extrudate as set forth in any one of embodiments 1-6 or 12-19, wherein the extrudate further comprises an acidifier (pH control agent/sequestrant), such as glucono delta-lactone (GDL).

Embodiment 22 is an extrudate as set forth in any one of embodiments 1-8 or 12-21, wherein the hydrocolloid comprises or is a combination of pectin and alginate.

Embodiment 23 is an extrudate as set forth in any of the preceding embodiments, wherein the plant protein is chickpea (Cicer arietinum) protein and/or faba bean (Vicia faba) protein.

Embodiment 24 is an extrudate as set forth in any of the preceding embodiments, wherein the plant protein comprises potato protein.

Embodiment 25 is an extrudate as set forth in any of the preceding embodiments, wherein the extrudate has a moisture content of no more than about 12 wt %, 10 wt %, 8 wt %, 6 wt %, 4 wt %, 2 wt %, or 1 wt % based on the total weight of the extrudate.

Embodiment 26 is an extrudate as set forth in any of the preceding embodiments, wherein the extrudate has a water binding ratio of at least about 3.

Embodiment 27 is an extrudate as set forth in any of the preceding embodiments, wherein the extrudate is substantially free or free of gluten.

Embodiment 28 is an extrudate as set forth in any of the preceding embodiments, wherein the extrudate has a density of from about 0.30 g/cm³ to about 0.70 g/cm³.

Embodiment 29 is an extrudate as set forth in any of the preceding embodiments, wherein the extrudate comprises macrostructural fibrous elements (strands, sheets and chunks) that are substantially aligned.

Embodiment 30 is an extrudate as set forth in any of the preceding embodiments, wherein the extrudate comprises plant protein fibers that are substantially aligned, and an average of at least 55% of the plant protein fibers present in the extrudate are substantially aligned.

Embodiment 31 is a dry-blend composition comprising, by weight based on the total weight of the dry-blend composition on a moisture-free basis, (a) from about 65% to about 98% plant protein material such as a soy protein material selected from the group consisting of soy protein isolate, soy protein concentrate, and combinations thereof; (b) from about 1% to about 10% hydrocolloid, wherein the hydrocolloid is selected from the group consisting of alginate, pectin, agar, methylcellulose, and mixtures thereof; and (c) optionally, no more than about 14% starch.

Embodiment 32 is a dry-blend composition as set forth in embodiment 31, wherein the dry-blend composition comprises at least about 65%, 67%, 69%, 71%, 73%, 75%, 77%, 79%, 81%, 83%, 85%, or 86% plant protein material.

Embodiment 33 is a dry-blend composition as set forth in embodiments 31 or 32, wherein the dry-blend composition comprises no more than about 98%, 97%, 96%, 95%, 94%, 93%, 92%, 91%, 90%, 89%, or 88% plant protein material.

Embodiment 34 is a dry-blend composition as set forth in any one of embodiments 31-33, wherein the dry-blend composition comprises no more than about 14%, 13%, 12%, 11%, 10%, 9%, 8%, 7%, or 6% starch.

Embodiment 35 is a dry-blend composition as set forth in any one of embodiments 31-34, wherein the dry-blend composition comprises at least about 0.001%, 0.01%, 0.1%, 0.5%, 1%, 2%, 3%, 4%, or 5% starch.

Embodiment 36 is a dry-blend composition as set forth in any one of embodiments 31-35, wherein the dry-blend composition comprises at least about 1%, 1.5%, 2%, 2.5%, 3%, 3.5%, or 4% hydrocolloid.

Embodiment 37 is a dry-blend composition as set forth in any one of embodiments 31-36, wherein the dry-blend composition comprises no more than about 10%, 9%, 8%, 7%, 6.5%, 6%, 5.5%, 5%, 4.5% or 4% hydrocolloid.

Embodiment 38 is a dry-blend composition as set forth in any one of embodiments 31-37, wherein the hydrocolloid is an alginate selected from the group consisting of calcium alginate, potassium alginate, sodium alginate, and combinations thereof.

Embodiment 39 is a dry-blend composition as set forth in any one of embodiments 31-38, wherein the hydrocolloid is a mixture of sodium alginate and calcium alginate.

Embodiment 40 is a dry-blend composition as set forth in any one of embodiments 31-37, wherein the hydrocolloid is an alginate and the dry-blend composition further comprises at least about 0.05%, 0.1%, 0.2%, 0.3%, 0.4%, 0.5%, 0.6%, 0.7%, 0.8%, 0.9%, 1%, 1.2%, 1.5%, 1.8%, or 2% sparingly soluble calcium compound.

Embodiment 41 is a dry-blend composition as set forth in any one of embodiments 31-37 or 40, wherein the hydrocolloid is an alginate and the dry-blend composition further comprises no more than about 10%, 9%, 8%, 7%, 6%, 5%, 4%, 3%, or 2% sparingly soluble calcium compound.

Embodiment 42 is a dry-blend composition as set forth in embodiments 40 or 41, wherein the sparingly soluble calcium compound is selected from the group consisting of calcium sulphate, calcium phosphates (e.g., di-calcium phosphate), calcium citrate, calcium carbonate, calcium silicate, calcium sulfide, calcium tartrate, and mixtures thereof.

Embodiment 43 is a dry-blend composition as set forth in any one of embodiments 40-42, wherein the dry-blend composition further comprises a sequestrant such as one selected from the group consisting of tetra sodium pyrophosphate (TSPP), trisodium phosphate (TSP), disodium phosphate (DSP), sodium-hexametaphosphate (SHMP), trisodium citrate, and mixtures thereof.

Embodiment 44 is a dry-blend composition as set forth in any one of embodiments 40-42, wherein the sparingly soluble calcium compound is calcium carbonate, and the dry-blend composition optionally further comprises glucono delta-lactone (GDL) as an acidifier.

Embodiment 45 is a dry-blend composition as set forth in any one of embodiments 31-37, wherein the hydrocolloid is calcium alginate.

Embodiment 46 is a dry-blend composition as set forth in any one of embodiments 31-37, wherein the hydrocolloid is a pectin having an averaged DE of at least 50, and the dry-blend composition is substantially free or free of a calcium-containing compound such as a sparingly soluble calcium compound.

Embodiment 47 is a dry-blend composition as set forth in any one of embodiments 31-46, wherein the dry-blend composition further comprises an added fiber ingredient in an amount of no more than about 6%, 5%, 4%, 3% or 2%.

Embodiment 48 is a dry-blend composition as set forth in any one of embodiments 31-47, wherein the dry-blend composition further comprises an added fiber ingredient in an amount of at least about 0.5%, 1%, 2%, 3%, 4%, or 5%.

Embodiment 49 is a dry-blend composition as set forth in embodiments 47 or 48, wherein the added fiber ingredient is selected from the group consisting of soy fiber, citrus fiber, pea fiber, and combinations thereof.

Embodiment 50 is a dry-blend composition as set forth in any one of embodiments 31-49, wherein the dry-blend composition has a moisture content of no more than about 10 wt %, 8 wt %, 6 wt %, 4 wt %, 2 wt %, or 1 wt % based on the total weight of the dry-blend composition.

Embodiment 51 is a dry-blend composition as set forth in any one of embodiments 31-50, wherein the dry-blend composition is substantially free or free of a gluten.

Embodiment 52 is an extrusion process, such as a low-moisture extrusion process, comprising: (a) contacting a dry-blend composition as set forth in any one of embodiments 31-51 with water to form a feed mixture; (b) feeding the feed mixture into an extruder to form a molten extrusion mass; and (c) extruding the molten extrusion mass through an extrusion die to produce an extrudate.

Embodiment 53 is a process of preparing a hydrated extrudate, comprising hydrating an extrudate as set forth in any one of embodiments 1-30 in an aqueous solution to form the hydrated extrudate.

Embodiment 54 is a process as set forth in embodiment 53, wherein the hydrating process is conducted by soaking the extrudate in an aqueous solution optionally comprising a spice and/or a flavor.

Embodiment 55 is a process as set forth in embodiments 53 or 54, wherein the hydrating process is conducted under vacuum, such as under at least about 20% vacuum.

Embodiment 56 is a process as set forth in any one of embodiments 53-55, wherein the hydration time is from about 30 min to about 180 min, or from about 60 min to about 120 min, or from about 90 min to about 120 min.

Embodiment 57 is a process as set forth in any one of embodiments 53-56, wherein the hydrated extrudate comprises at least about 15 wt % of fragments comprised of macrostructural fibrous elements comprising strands of at least about 1 cm long or ⅓ the length of the dry-extrudate, and/or sheets of at least about 1 cm long or ⅓ the length of the dry-extrudate and which sheets are at least 1 cm wide or ½ the width of the dry-extrudate, and/or chunks of at least about 1 cm long or ⅓ the length of the dry-extrudate, of at least 1 cm wide or ½ the width of the dry-extrudate and of up to 1 cm thick or ½ the thickness of the dry-extrudate.

Embodiment 58 is a process as set forth in any one of embodiments 53-57, wherein the hydrated extrudate comprises at least about 15 wt %, 20 wt %, 22 wt %, 24 wt %, 26 wt %, 28 wt %, 30 wt %, 32 wt %, 34 wt %, 36 wt %, 38 wt %, 40 wt %, 42 wt %, 44 wt %, 46 wt %, or 48 wt % macrostructural fibrous elements (strands, sheets and chunks) based on the weight of the hydrated extrudate.

Embodiment 59 is a process as set forth in any one of embodiments 53-58, wherein the hydrated extrudate comprises no more than about 75 wt %, 70 wt %, 68 wt %, 66 wt %, 64 wt %, 62 wt %, 60 wt %, 58 wt %, 56 wt %, or 54 wt % macrostructural fibrous elements (strands, sheets and chunks) based on the weight of the hydrated extrudate.

Embodiment 60 is a process as set forth in any one of embodiments 53-59, wherein the hydrated extrudate has average shear strength of at least about 1400 grams, such as at least about 1500, 1600, 1700, 1800, 1900, 2000, 2200, 2400, 2600, 2800, 3000, 3200, 3400, 3600, or 3800 grams.

Embodiment 61 is a process as set forth in any one of embodiments 53-60, wherein the hydrated extrudate has average shear strength of no more than about 6000, 5500, 5000, 4800, 4600, 4400, 4200, 4100, 4000, or 3900 grams.

Embodiment 62 is a ready-to-use meat alternative food product prepared according to any one of embodiments 53-61.

1. An extrudate comprising, by weight based on the weight of the extrudate on a moisture-free basis,
(a) from about 60% to about 90% plant protein;
(b) from about 1% to about 10% hydrocolloid, wherein the hydrocolloid is selected from the group consisting of alginate, pectin, agar, methylcellulose, and mixtures thereof; and
(c) optionally, no more than about 14% starch.

2. The extrudate of claim 1, wherein the extrudate is a low-moisture extrudate.

3. The extrudate of claim 1, wherein the plant protein is selected from the group consisting of soy protein, pea protein, and combinations thereof.

4. The extrudate of claim 1, wherein the plant protein is a soy protein.

5. The extrudate of claim 1, wherein the hydrocolloid is an alginate, and the extrudate further comprises calcium ions.

6. The extrudate of claim 1, wherein the hydrocolloid is calcium alginate.

7. The extrudate of claim 1, wherein the extrudate has GDL content ranging from about 0.1% to about 10%.

8. An extrudate comprising, by weight based on the weight of the extrudate on a moisture-free basis,
(a) from about 80% to about 96% soy protein isolate;
(b) from about 2% to about 10% calcium alginate; and
(c) from about 2% to about 10% starch.

9. The extrudate of claim 1, wherein the extrudate comprises soy protein fibers, and an average of at least 55% of the soy protein fibers present in the extrudate are substantially aligned.

10. A dry-blend composition comprising, by weight based on the total weight of the dry-blend composition on a moisture-free basis,
(a) from about 65% to about 98% plant protein material;
(b) from about 1% to about 10% hydrocolloid, wherein the hydrocolloid is selected from the group consisting of alginate, pectin, agar, methylcellulose, and mixtures thereof; and
(c) optionally, no more than about 14% starch.

11. The dry-blend composition of claim 10, wherein the hydrocolloid is an alginate and the dry-blend composition further comprises a sparingly soluble calcium compound and a sequestrant.

12. The dry-blend composition of claim 10, wherein the hydrocolloid is an alginate and the dry-blend composition further comprises from about 0.3% to about 3% calcium carbonate and from about 0.3% to about 3% glucono delta lactone.

13. The dry-blend composition of claim 10, wherein the plant protein material is soy protein isolate and the hydrocolloid is calcium alginate.

14. An extrusion process comprising:
(a) contacting the dry-blend composition of claim 10 with water to form a feed mixture;
(b) feeding the feed mixture into an extruder to form a molten extrusion mass; and
(c) extruding the molten extrusion mass through an extrusion die to produce an extrudate.

15. A process of preparing a hydrated extrudate, comprising hydrating the extrudate of claim 1 in an aqueous solution to form the hydrated extrudate.

16. The extrudate of claim 8, wherein the extrudate comprises soy protein fibers, and an average of at least 55% of the soy protein fibers present in the extrudate are substantially aligned.

17. A process of preparing a hydrated extrudate, comprising hydrating the extrudate of claim 8 in an aqueous solution to form the hydrated extrudate.
